(19) United States
(12) Patent Application Publication
(10) Pub. No.: US 2005/0126352 A1
(43) Pub. Date: Jun. 16, 2005

(54) Method for performing delta volume decomposition and process planning in a turning step-nc system

(75) Inventors: Suk-Hwan Suh, Pohang-shi (KR); Sang-Uk Cheon, Ponang-shi (KR); Byeong-Eon Lee, Pohang-shi (KR)

Correspondence Address: BACON & THOMAS, PLLC, 625 SLATERS LANE, FOURTH FLOOR, ALEXANDRIA, VA, 22314, US

(73) Assignee: POSTECH FOUNDATION, Pohang-shi (KR)

(21) Appl. No.: 10/507,370

(22) PCT Filed: Aug. 26, 2002
(86) PCT No.: PCT/KR02/01605

(30) Foreign Application Priority Data
Mar. 25, 2002 (KR) 2002-0016154

(51) Int. Cl. B23B 3/00

(52) U.S. Cl. 82/1.11

(57) ABSTRACT

A profile of a finished part is recognized based on an inputted CAD data. A delta volume for the finished part is decomposed based on information on cutting tools and the profile. Thereafter, a dependency graph representing precedence relation between the decomposed delta volumes is generated. And then, a process sequence graph representing process plans is generated based on the dependency graph. The delta volume decomposition is performed based on information on cutting tools and a machine configuration as well as part geometry, such that the decomposed delta volumes are suitable to be cut away from a raw stock by the cutting tools.

### FIELD OF THE INVENTION

The present invention relates to a method for automatically generating process plans for use in a turning machine; and, more particularly, to a method for decomposing a delta volume based on information on cutting tools and CAD data including geometry information on a finished part and, thereafter, based on the results of the delta volume decomposition, generating process plans for use in cutting a body of revolution in a turning machine.

### BACKGROUND OF THE INVENTION

In general, a conventional method for automatically cutting mechanical parts in a turning machine generates a process plan based on information on the geometry of the mechanical parts without considering the characteristics of the actual turning process. The conventional method includes the steps of: (i) processing information on a profile of a finished part, which is inputted as a file; (ii) recognizing a part geometry based on the profile; and (iii) processing the recognized part geometry to be outputted. Since such a conventional method uses a relatively simple method for recognizing part geometry, it has disadvantage in that one part, which may be cut at once by using one cutting tool, is recognized as several subdivided parts. Further, since the conventional method subdivides a delta volume (i.e., a volumetric difference between a raw stock and a part defining a material that must be cut away during the actual machining process) into smaller volumes without considering cutting tool characteristics, the decomposed delta volumes may not be suitable to be cut by using the cutting tool and, therefore, may need to be post-processed.

For example, commercial machining supporting systems equipped in a typical CNC system, Fanuc 15-TF of Fanuc, Inc. and Mazatrol T32-2 of Mazak, Inc., have a problem in that the systems do not support an interface for inputting/outputting a CAD file. Further, in these systems, part geometry and process plans must be manually defined, and it is difficult to select a cutting tool for processing an uncut part. On the contrary, one of offline CAM systems, ProCAM 2D of TekSoft, Inc., has advantages in that it supports an interface for inputting/outputting a CAD file, performs easily a geometry design, and automatically recognizes an uncut part. However, it has disadvantage in that delta volumes must be defined manually since it does not define a concept of part geometry.

Accordingly, there is needed a method for automatically generating a process plan by performing delta volume decomposition based on not only part geometry but also cutting tool information.

### SUMMARY OF THE INVENTION

It is, therefore, an object of the present invention to provide a method for decomposing a delta volume into smaller volumes based on not only part geometry but also cutting tool information and automatically generating process plans based on the results of the delta volume decomposition.

In accordance with a preferred embodiment of the present invention, there is provided a method for performing delta volume decomposition and process planning in a turning STEP-NC system, comprising the steps of: (a) based on a CAD data file including geometry information on a raw stock and a finished part, recognizing a profile of the finished part; (b) setting a machine configuration of a turning machine based on the recognized profile; (c) splitting the profile based on the machine configuration; (d) decomposing a delta volume corresponding to each of the split profiles; (e) generating a dependency graph based on the decomposed delta volumes, wherein the dependency graph represents operational precedence relations between the decomposed delta volumes; (f) generating a PSG (process sequence graph) representing a process plan based on the dependency graph; (g) editing the decomposed delta volumes and/or the PSG; and (h) generating a part program based on the PSG.

In accordance with another preferred embodiment of the present invention, there is a method for decomposing a delta volume for use in a turning STEP-NC system, comprising the steps of: (a) splitting a profile of a finished part into N profiles based on a setup and/or a machine configuration, wherein N is a positive integer; (b) recognizing an inherent delta volume based on information on each of the split profiles; (c) updating an input profile by calculating a union of the inherent delta volume and the profile of the finished part; (d) based on the input profile, determining a reference line such that a minimum number of monotone chains are obtained based on the reference line; (e) determining a maximum monotone chain by connecting the monotone chains; and (f) selecting a first turning tool and recognizing a primary delta volume and/or an uncut delta volume based on information on the first turning tool and the maximum monotone chain.

### BRIEF DESCRIPTION OF THE DRAWINGS

The above and other objects and features of the present invention will become apparent from the following description of preferred embodiments, given in conjunction with the accompanying drawings, in which:

FIG. 1 illustrates typical work-pieces to be machined and cutting tools for cutting the work-pieces;

FIGS. 2A and 2B describe a simple delta volume and a compound delta volume, respectively, defined in accordance with the present invention;

FIG. 3 depicts an inherent delta volume, a primary delta volume and an uncut delta volume defined in accordance with the present invention;

FIG. 4 shows a turning tool represented by several parameters and an abstract turning tool corresponding thereto;

FIG. 5 charts a process of cutting a work-piece by using an abstract turning tool;

FIGS. 6A and 6B exhibit profiles of the delta volumes shown in FIGS. 2A and 2B, respectively;

FIG. 7 sets forth profiles of basic parts together with monotone chains and reference lines corresponding thereto;

FIG. 8 explains abstract turning tools corresponding to the reference lines of the monotone chains shown in FIG. 7;

FIGS. 9A and 9B describe turning tool settings in accordance with different reference lines for the same part;

FIGS. 10A and 10B depict a method for determining whether a curve segment is monotone or not in accordance with the present invention;

FIGS. 11A to 11C illustrate a left-hand insert, a right-hand insert and a neutral insert together with FMRs (feasible machining ranges) thereof, respectively;

FIGS. 12A and 12B set forth a method for calculating an FMR of a cutting tool in accordance with the present invention;

FIGS. 13A and 13B chart definitions of SED and EED of an insert and a method for determining whether a cutting tool interferes with a stock by using the SED and EED of the cutting tool in accordance with the present invention;

FIG. 14 explains a definition of a characteristic vertex and a method for determining an uncut region in a stock by using the characteristic vertex in accordance with the present invention;

FIGS. 15A and 15B exhibit an example of a finished part, a primary delta volume and an uncut delta volume for the finished part, respectively, which are decomposed in accordance with the present invention;

FIG. 16 describes a method for calculating an uncut delta volume by using a characteristic vertex in accordance with the present invention;

FIG. 17 depicts examples of inherent delta volumes defined in accordance with the present invention;

FIGS. 18A and 18B set forth a method for recognizing an inherent delta volume in accordance with the present invention;

FIGS. 19A and 19B show a method for processing non-monotone segments of a profile of a part in accordance with the present invention;

FIGS. 20A to 20C chart a process of decomposing a delta volume for a part in accordance with the present invention;

FIGS. 21A to 21D depict a process of decomposing a delta volume for a complicated part in accordance with the present invention;

FIG. 22 charts a dependency relation between delta volumes decomposed in accordance with the present invention;

FIG. 23A illustrates an example of a part and delta volumes therefor decomposed by using a method in accordance with the present invention;

FIG. 23B sets forth a dependency graph for the delta volumes shown in FIG. 23A;

FIG. 24 exhibits another dependency graph for the delta volumes shown in FIG. 23A;

FIGS. 25A and 25B describe exemplary dependency graphs including an auxiliary dependency in accordance with the present invention;

FIGS. 26A to 26E show an exemplary dependency graph and non-linear PSGs generated based on the dependency graph, respectively;

FIGS. 27A and 27B depict an example of a parallel mill/turn machining center and MUs (machining units) included therein, respectively;

FIG. 28 charts a turning worksheet showing operations and time required for the operations;

FIGS. 29A to 29D illustrate PSGs (process sequence graphs) generated by using the turning worksheet shown in FIG. 28;

FIG. 30 explains a process plan for the parallel mill/turn machining center having the MUs shown in FIGS. 27A and 27B, which is generated based on the PSGs shown in FIGS. 29A to 29D;

FIGS. 31A and 31B set forth a notation of a tolerance on a drawing for use in turning;

FIG. 32 describes a notation of a surface roughness on a drawing for use in turning;

FIG. 33 charts sampled values of surface roughness and graphs related thereto;

FIG. 34 shows an exemplary non-linear PSG for a secondary finish contouring, which is generated based on a tolerance and a surface roughness.

FIGS. 35A to 35F depict the steps of a method for performing a delta volume decomposition to be used in a parallel mill/turn machining center in accordance with the present invention;

FIGS. 36A to 36D chart non-linear PSGs generated based on the results of the delta volume decomposition shown in FIGS. 35A to 35F;

FIG. 37 exhibits a block diagram showing a system for automatically generating process plans based on the results of delta volume decomposition in accordance with the present invention;

FIG. 38 illustrates a block diagram showing components of the system shown in FIG. 37;

FIG. 39 shows a block diagram showing a process of analyzing CAD data, which is a detailed diagram of the block A1 shown in FIG. 38;

FIG. 40 explains a block diagram showing a process of setting up a machine configuration, which is a detailed diagram of the block A2 shown in FIG. 38;

FIG. 41 shows a block diagram showing a process of decomposing a delta volume, which is a detailed diagram of the block A3 shown in FIG. 38;

FIG. 42 shows a block diagram showing a process of generating a non-linear PSG, which is a detailed diagram of the block A4 shown in FIG. 38; and

FIG. 43 shows a block diagram showing a process of generating an ISO 14649 part program based on the non-linear PSG, which is a detailed diagram of the block A5 shown in FIG. 38.

### DESCRIPTION OF SPECIFIC EMBODIMENTS

A finished part to be machined in a turning machine may be represented by using a profile thereof. A shape of a part, which is cut away during the turning process, varies depending on a cutting tool to be used in cutting the part. The recognition of the parts to be machined can be accomplished through a decomposing of a delta volume, i.e., a material that must be cut away during the actual machining process. Since the finished part is symmetric with respect to an axis and is cut by revolving the axis and moving a cutting tool two-dimensionally with respect to the axis, the delta volume can be represented by a two-dimensional profile thereof.

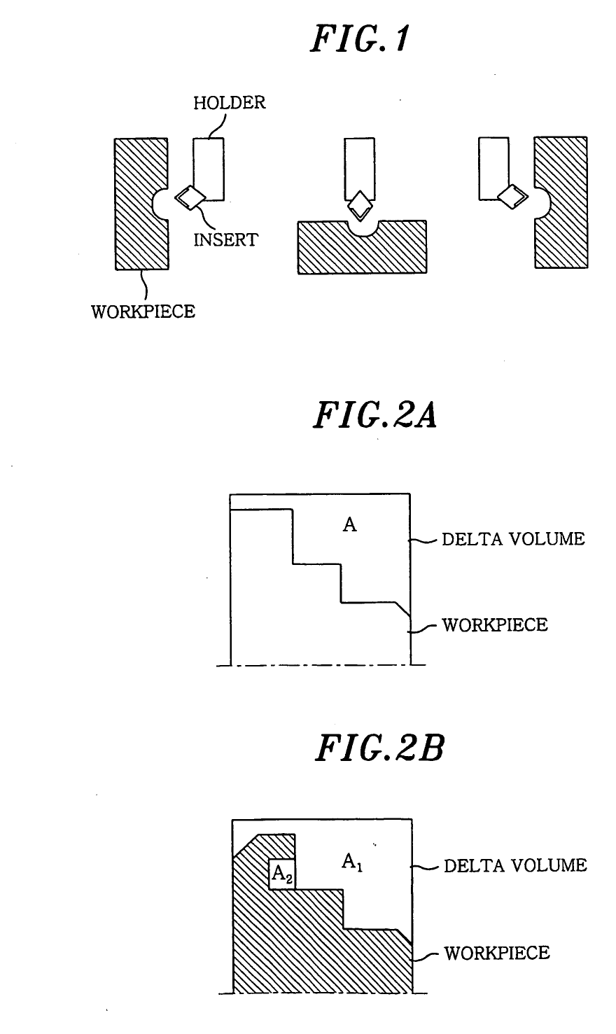

Turning characteristics to be considered in determining the delta volume are as follows. Firstly, a cutting tool must remove as much delta volume material as possible. Secondly, a delta volume is determined based on the type of the cutting tool. That is, in a raw stock, a feasibly cuttable volume and an uncut volume are determined. Thirdly, a certain volume may have to be cut by using a cutting tool dedicated thereto. That is, depending on the geometry of a delta volume, (a) a type of a cutting tool, (b) a cutting direction of an insert of the cutting tool, i.e., a position of a theoretical sharp corner of the cutting tool, and (c) a position of a tool holder are determined. FIG. 1 shows work-pieces, each of which has an identical shape but is located at a different position. As shown in FIG. 1, a position of a theoretical sharp corner of the cutting tool varies depending on the position of a work-piece to be machined by using the cutting tool.

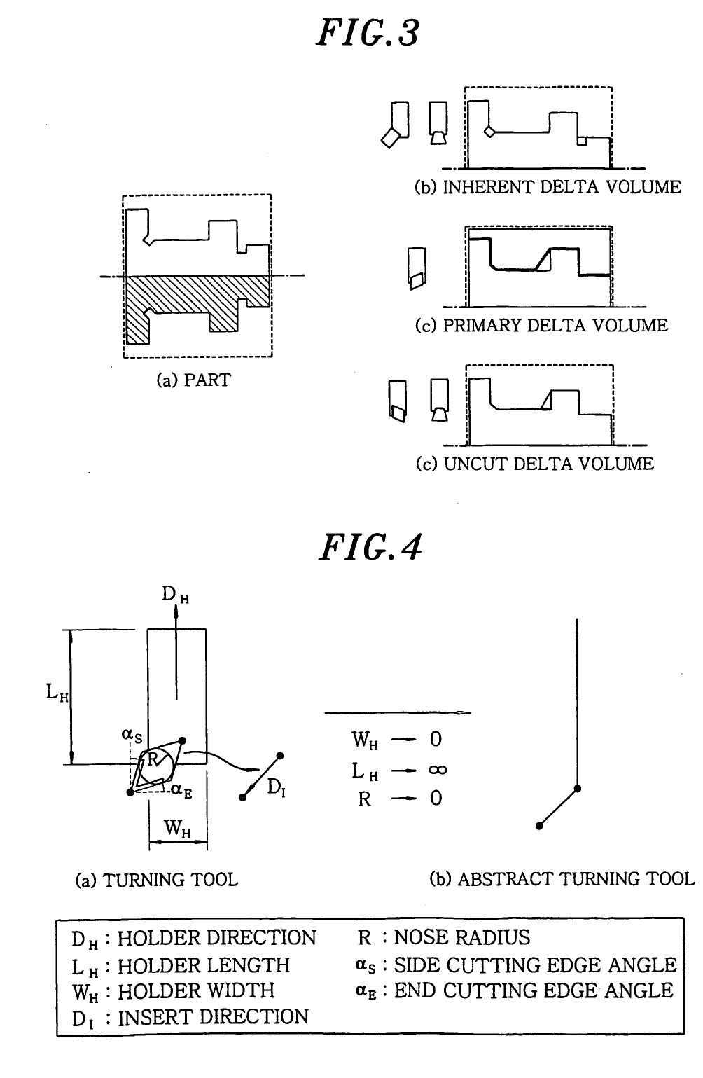

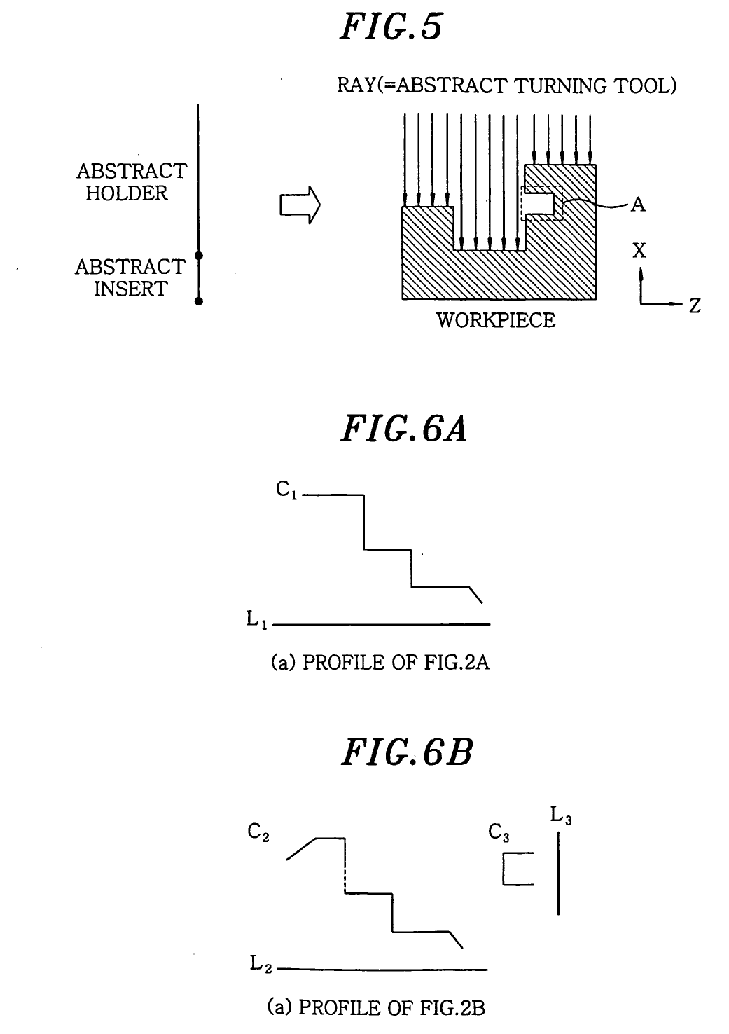

A decomposition of a delta volume is a process of subdividing a volume, which is to be cut away by using a cutting tool, into several smaller volumes. The result of the delta volume decomposition depends on the type of the cutting tool. In the present invention, a delta volume is categorized into two types: a simple delta volume and a compound delta volume. The simple delta volume is a delta volume that can be entirely cut by using one cutting tool. Meanwhile, the compound delta volume is a delta volume requiring more than one cutting tool for cutting thereof. FIGS. 2A and 2B illustrate examples of a simple delta volume and a compound delta volume, respectively. A delta volume A shown in FIG. 2A can be cut by using one cutting tool. A compound delta volume shown in FIG. 2B includes two simple delta volumes A₁ and A₂, each of which can be cut by using one cutting tool.

The simple delta volume can be further categorized into several types: a primary delta volume, an uncut delta volume and an inherent delta volume. FIG. 3 shows a part (a) to be machined together with an inherent delta volume (b), a primary delta volume (c) and an uncut delta volume (d) for the part (a). A process of cutting such delta volumes as shown in FIG. 3 will be described later in detail.

FIG. 4 illustrates an exemplary turning tool (a) together with parameters for describing characteristics of the turning tool. As shown in FIG. 4, if it is assumed that W_{H}→0, L_{H}→∞, R→0, the turning tool (a) can be represented by a turning tool (b) consisting of a ray, i.e., a half infinite line, and a line segment. In the present invention, such a turning tool (b) is referred to as an abstract turning tool. Among the parameters of the turning tool (a), a parameter for representing a direction of the cutting tool, i.e., D_{H} is limited to a vector (1,0,0), (−1,0,0), (0,0,1) or (0,0,−1) in the turning coordinates. Accordingly, a feasible machining range of the turning tool can be determined by setting only α_{S} and α_{E}.

FIG. 5 charts a process of cutting a work-piece by using an abstract turning tool. As shown in FIG. 5, if there is a directional light source irradiating a ray on a work-piece from the direction of +X to that of −X, the ray cannot reach an area A, so that the area A is in the shade. If such a ray is converted into an abstract turning tool, the area A corresponds to an area that cannot be cut away by using the abstract turning tool.

In the present invention, a concept of a monotone chain is introduced in calculating a feasible machining range of an abstract turning tool. A chain is defined as a line segment graph including points {u₁, . . . , uₚ} and edges {(uᵢ, uᵢ₊₁): i=1, . . . , p−1} for connecting the points. If a chain C=(u₁, . . . , uₚ) intersects a line L⁰ perpendicular to a line L at only one point on the line L⁰, the chain C is defined to be monotone to the line L. The monotone chain is categorized into two types: a completely monotone chain and a monotone chain. That is, if an intersection of the chain C and the line L⁰ includes only points on the line L⁰, the chain C is defined to be completely monotone to the line L. On the other hand, if the intersection of the chain C and the line L⁰ includes not only points but also line segments on the line L⁰, the chain C is defined to be monotone.

By using the concepts of the abstract turning tool, the monotone chain and the delta volumes, it can be determined whether or not a profile of a delta volume is a monotone chain. For example, a profile of a simple delta volume is regarded as a monotone chain.

FIGS. 6A and 6B describe monotone chains representing profiles of the delta volumes shown in FIGS. 2A and 2B, respectively. As shown in FIG. 6A, the profile C₁ of the simple delta volume A₁ shown in FIG. 2A is monotone to a line L₁. Meanwhile, the profile of the compound delta volume (A₁+A₂) is non-monotone to any straight line. However, as shown in FIG. 6B, if the compound delta volume (A₁+A₂) is subdivided into two delta volumes A₁ and A₂, profiles C₂ and C₃ of the delta volumes A₁ and A₂ are monotone to lines L₂ and L₃, respectively.

In the following, a relation between a monotone chain and a turning tool will be described in detail.

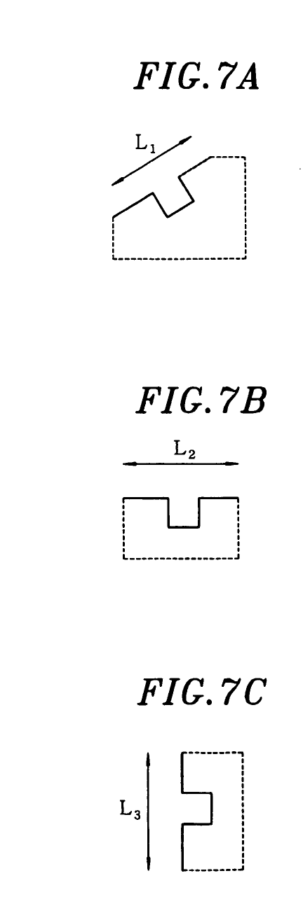

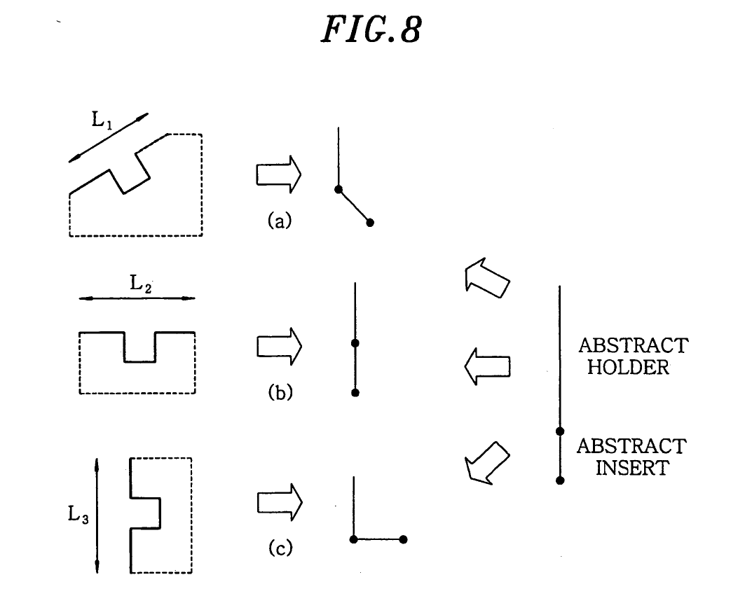

FIG. 7 explains monotone chains representing profiles of basic parts and corresponding reference lines. In FIG. 7, if solid lines are chains corresponding to areas to be machined, each of the chains is monotone to each of the corresponding lines L₁, L₂ and L₃. In the present invention, such a line is defined as a reference line of a corresponding monotone chain. The reference line may be determined by using the following procedure. That is, if a monotone chain consists of only line segments, a line L perpendicular to each of the line segments can be determined. In this case, if the line L is monotone to all the line segments, the line L becomes a reference line of the monotone chain. The reference line of the monotone chain is used in determining a turning tool for cutting a delta volume corresponding to the monotone chain.

FIG. 8 exhibits relations between monotone chains and corresponding turning tools. As shown in FIG. 8, it is preferable that an abstract turning tool for a monotone chain is determined such that an insert of the turning tool is perpendicular to a reference line of the monotone chain.

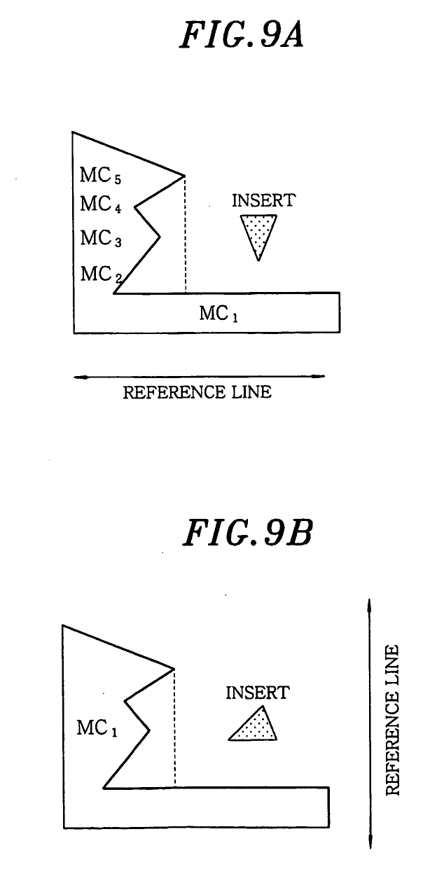

FIGS. 9A and 9B describe turning tool settings in accordance with different reference lines for a same part. In FIGS. 9A and 9B, thick solid lines represent chains corresponding to parts to be machined. If a reference line is set as shown in FIG. 9A, a profile of the part to be machined can be divided into 5 monotone chains MC₁, MC₂, MC₃, MC₄ and MC₅. On the other hand, if a reference line is set as shown in FIG. 9B, a profile of the part to be machined can be considered as one monotone chain MC₁. According to the method for setting turning tools as shown in FIG. 8, the part may be cut by using a turning tool having such an insert as shown in FIGS. 9A and 9B. In this case, the turning tool having an insert shown in FIG. 9A cannot cut the areas corresponding to the monotone chains MC₁, MC₂, MC₃ and MC₄. However, the turning tool having an insert shown in FIG. 9B can cut the entire area corresponding to the monotone chain MC₁.

In the meanwhile, when the part to be machined has a curvilinear profile, a monotone chain and a corresponding reference line for the profile is determined as follows.

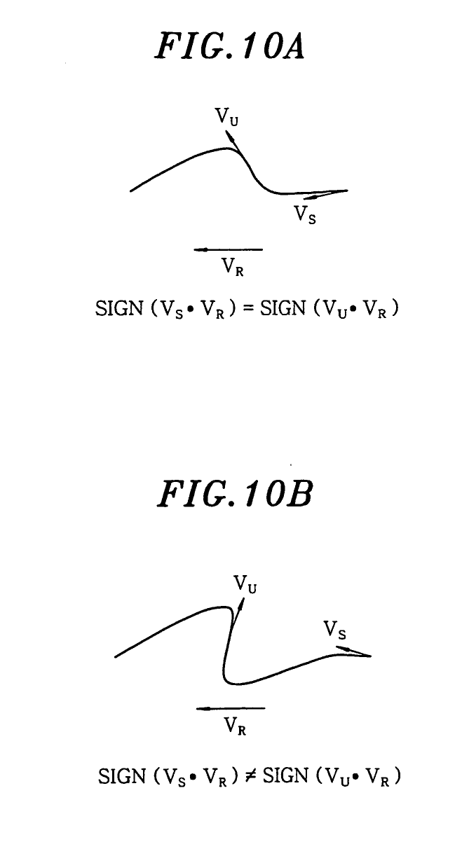

FIGS. 10A and 10B depict a method for determining whether or not a curve segment is monotone in accordance with the present invention. In FIGS. 10A and 10B, vectors V_{R}, V_{S} and V_{U} refer to a vector representing a reference line, a vector representing a tangent line at a start point of a curve segment and a vector representing a tangent line at a certain point of the curve, respectively. As shown in FIG. 10A, if sign(V_{S}·V_{R})=sign (V_{U}·V_{R}) for all points on the curve segment, wherein sign(V) means a sign of a vector V, the curve segment is defined to be monotone to the vector V_{R}. Meanwhile, as shown in FIG. 10B, if sign(V_{S}·V_{R})≠sign(V_{U}·V_{R}) for all points on the curve segment, the curve segment is defined to be non-monotone to the vector V_{R}. By using the above concept of monotony of a curve segment, a monotone chain and a corresponding reference line for the curve segment are determined by performing the steps of: (i) determining a plurality of line segments approximating the curve segment, wherein the line segments approximate the curve segment within an allowable error range; (ii) determining a monotone chain for the plurality of line segments; and (iii) determining a reference line for the monotone chain and selecting a turning tool therefor. In this case, the monotone chain represents the curve segment approximated by the line segments, and the reference line becomes a reference line for the curve segment.

In general, a turning tool is categorized into three types: a left-hand tool, a right-hand tool and a neural tool. Further, a range of an area cuttable by employing a turning tool is determined based on the type and a cutting direction of an insert of the turning tool and is referred to as an FMR (feasible machining range) of the turning tool in the present invention.

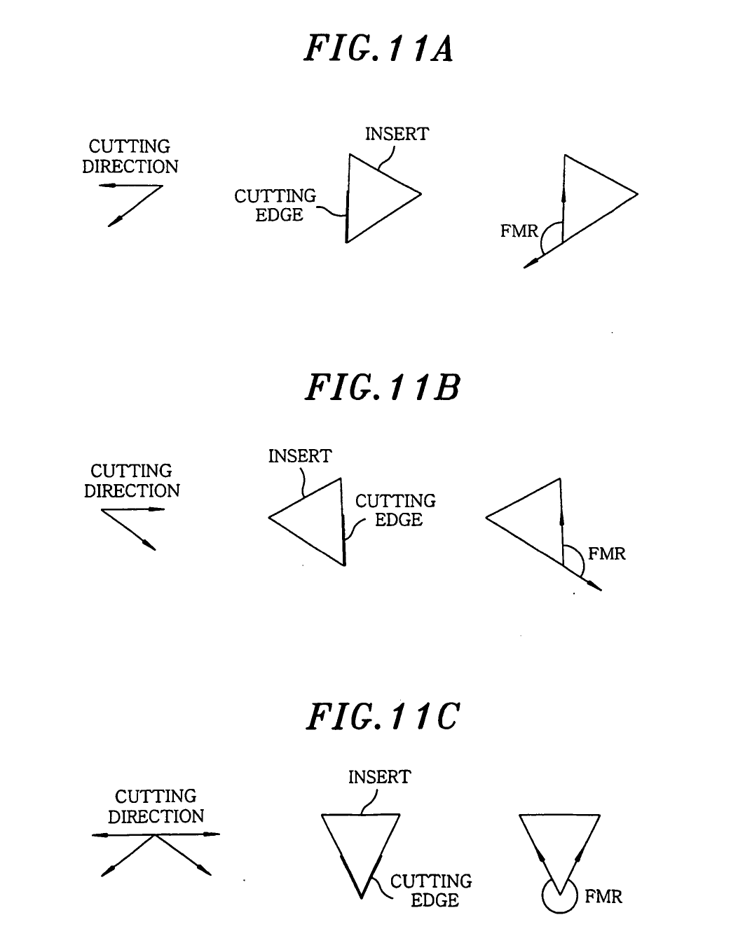

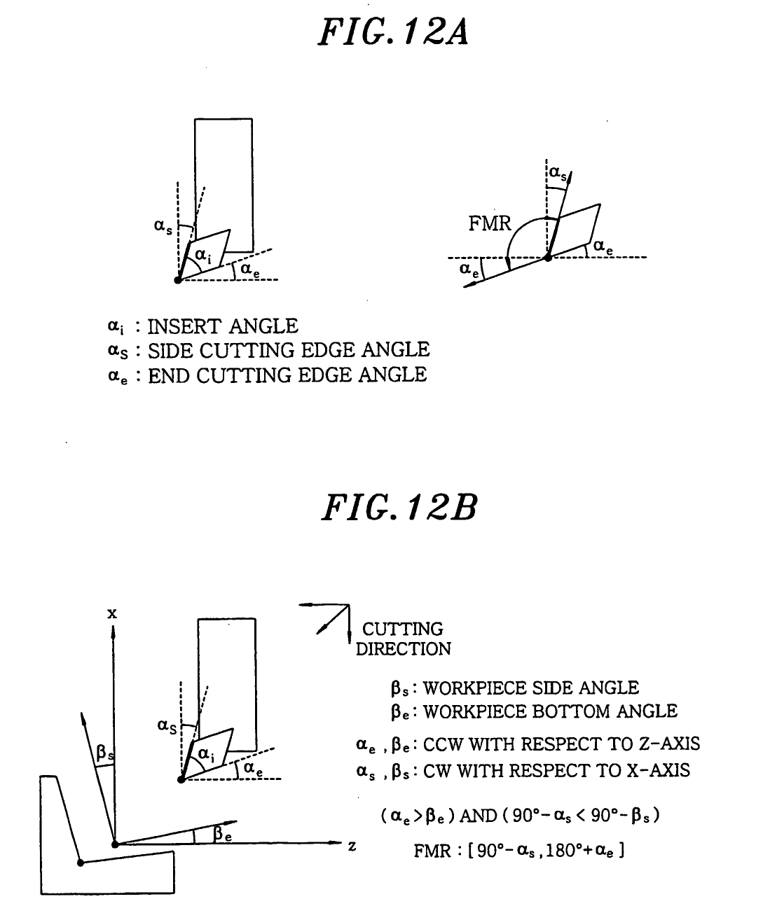

FIGS. 11A to 11C chart a left-hand tool, a right-hand tool and a neutral tool, respectively, together with FMRs thereof. As mentioned above, the FMR is determined based on a cutting direction and an angular range of a theoretical sharp corner of an insert. The FMR can be represented by a side cutting edge angle and an end cutting edge angle of an insert equipped in a bite. For example, as shown in FIGS. 12A and 12B, if αₛ and αₑ represent a side cutting edge angle and an end cutting edge angle, an FMR is [90°−αₛ, 180°+αₑ]. Herein, a positive direction of the side cutting edge is clockwise with respect to a vertical line, and a positive direction of the end cutting edge angle is counterclockwise with respect to a horizontal line. Further, by using a side cutting edge angle and an end cutting edge angle of an insert, it is determined whether or not the insert interferes with a part.

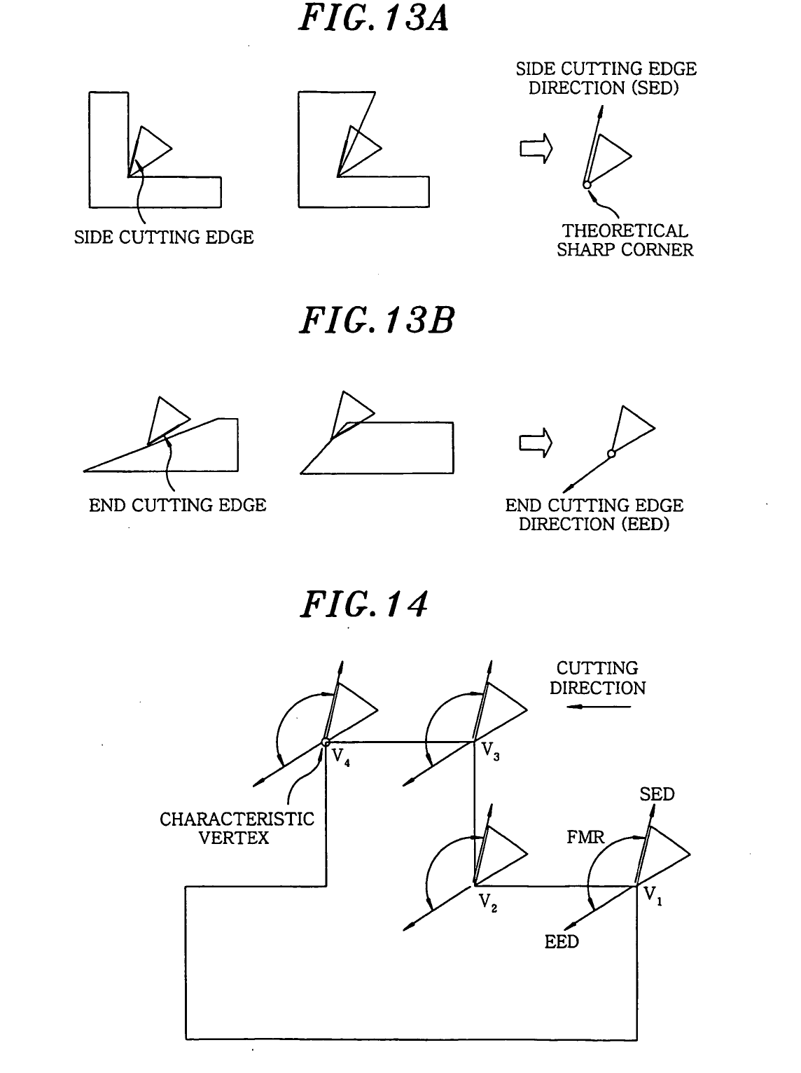

FIGS. 13A and 13B describe definitions of SED and EED and a method for determining whether or not a cutting tool interferes with a part in accordance with the present invention. In the present invention, the SED (side cutting edge direction) is defined as a vector directing from a theoretical sharp corner of an insert to a holder along a side cutting edge of the insert. The EED (end cutting edge direction) is defined as a vector directing away from a theoretical sharp corner of an insert in the direction of an end cutting edge of the insert.

FIG. 14 explains a definition of a characteristic vertex, and a method for determining an uncut region in a raw stock by using a characteristic vertex in accordance with the present invention. As shown in FIG. 14, when a monotone profile having a horizontal reference line is to be machined by an insert, rays irradiated from vertices V₁, V₂ and V₃ in the EED of the insert pass through a part. However, a ray irradiated from a vertex V₄ in the EED of the insert does not pass through the part. In the present invention, such a vertex V₄ is defined as a characteristic vertex. That is, for a certain point on a profile of a part, if a ray irradiated from the point in the EED of an insert does not pass through the part, the point is defined as a characteristic vertex.

By using such a characteristic vertex, an uncuttable area in a raw stock can be calculated. For example, if a profile of a part consists of a plurality of line segments arranged counterclockwise, a line segment next to a characteristic vertex will be an uncuttable area since the line segment interferes with an end cutting edge of an insert. On a monotone chain, only a convex vertex can be a characteristic vertex. A vertex is convex when an angle where two line segments cross at the vertex is smaller than π.

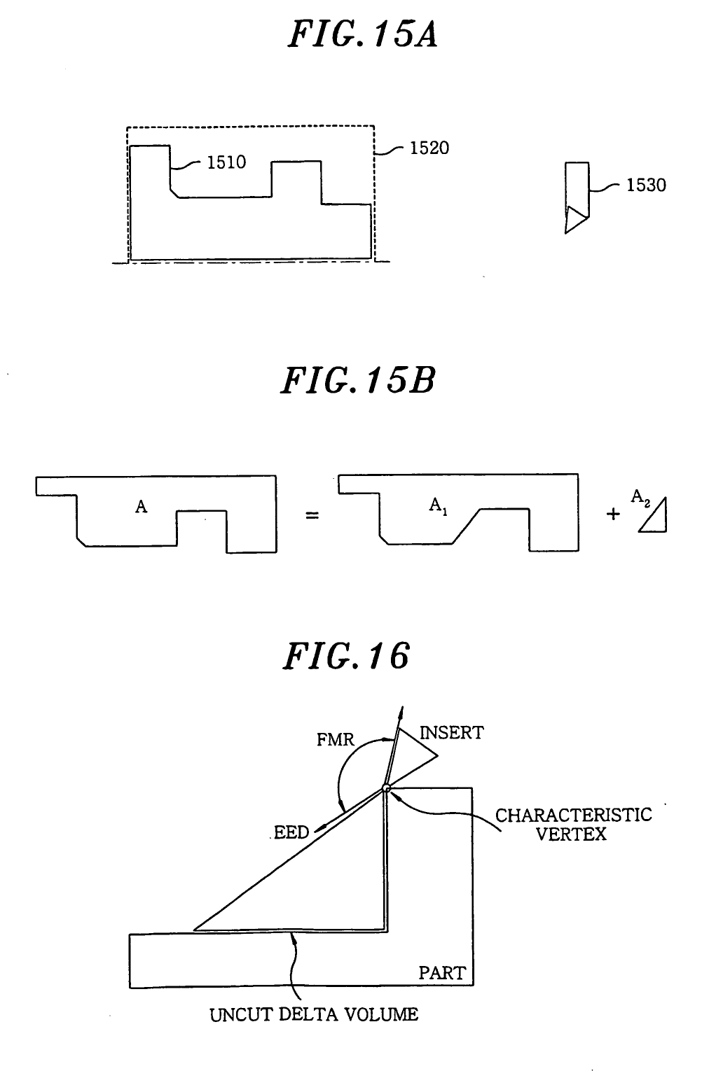

For instance, as shown in FIGS. 15A and 15B, if a raw stock 1520 is to be machined to obtain a finished part 1510, a delta volume A can be decomposed into two simple delta volumes A₁ and A₂. In this case, a turning tool 1530 can cut the delta volume A₁ but not the delta volume A₂. The delta volume A₁ is a maximum delta volume cuttable by the turning tool 1530. In the present invention, such a maximum delta volume cuttable by a turning tool is defined as a maximal simple delta volume. Further, if a profile of a delta volume is a monotone chain, a maximum simple delta volume for the delta volume is defined as a primary delta volume.

A primary delta volume for a turning tool is determined by using an FMR of the turning tool, which is selected for a maximal monotone chain of a profile of a part. By using the above-described definitions, a delta volume corresponding to a maximal monotone chain becomes a simple delta volume. Further, a delta volume obtained by subtracting an uncut delta volume from the simple delta volume becomes a primary delta volume. In the present invention, as shown in FIG. 15B, if a profile of the delta volume A is a monotone chain, the delta volume A₂ obtained by subtracting the maximal simple delta volume A₁ from the delta volume A is defined as an uncut delta volume.

FIG. 16 describes a method for calculating an uncut delta volume by using a characteristic vertex in accordance with the present invention. For instance, it is assumed that a vertex P₀ is a characteristic vertex, a vertex Pₜ is a vertex where a ray irradiated from the vertex P₀ in the EED of an insert crosses a profile of a part, and the vertex Pₜ lies on a segment (Pᵤ, Pᵤ₋₁). In this case, a delta volume having a profile consisting of a series of line segments (P₀, P₁), (P₁, P₂), . . . , (Pᵤ, Pₜ) and (Pₜ, P₀) becomes an uncut delta volume.

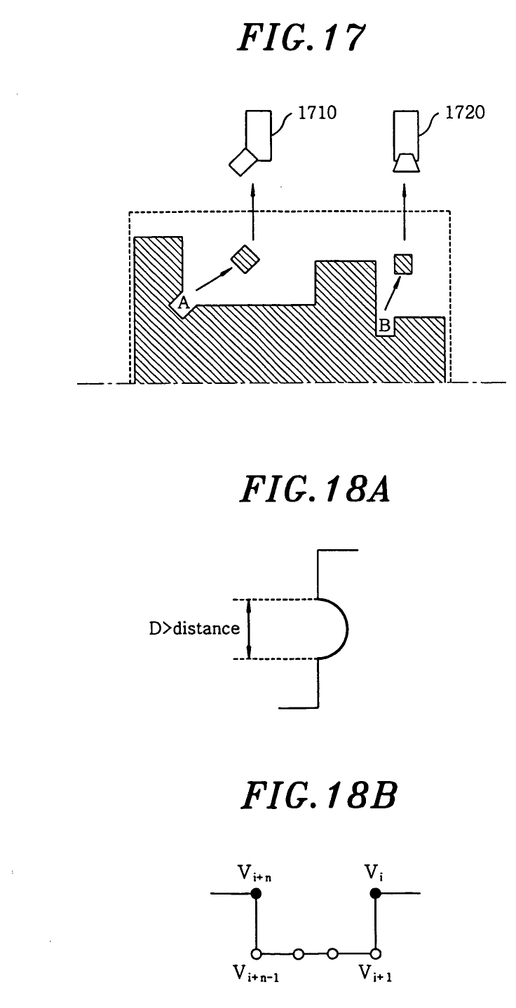

FIG. 17 depicts examples of inherent delta volumes in accordance with the present invention. As shown in FIG. 17, parts such as a cut-in A and a groove B must be cut away by using turning tools 1710 and 1720 suitable for the parts, respectively. In general, such a part is cut away by using a turning tool designed therefor after the other parts are machined. In the present invention, a simple delta volume corresponding to a part, which is to be machined by using a special turning tool designed therefor, is defined as an inherent delta volume.

FIGS. 18A and 18B set forth a method for recognizing an inherent delta volume in accordance with the present invention. A profile (or a segment) of a part is regarded as an inherent delta volume if the following conditions are satisfied. First, the segment is an arc, and a distance between a start point and an end point of the segment is less than a maximum diameter D for the inherent delta volume (refer to FIG. 18A). Second, in a sub-chain C={Vᵢ, . . . , Vᵢ₊ₙ}, vertices Vᵢ and Vᵢ₊ₙ (n≧1) are convex, a vertex Vⱼ (i<j<i+n) is reflex, and |Vᵢ-Vᵢ₊ₙ|<D (refer to FIG. 18B).

Until now, types of delta volumes and a method for recognizing thereof have been described. Hereinafter, there will be described in detail a method for decomposing a delta volume into a primary delta volume, an uncut delta volume and an inherent delta volume. Given a part to be machined, a decomposition of a delta volume for the part is performed as follows.

Step 1: Based on a setup or a machine configuration, a profile of the part is subdivided into N segments. And then, the following steps are performed for each of the N segments.

Step 2: An inherent delta volume is recognized for each of the N segments. An input profile is updated by using the recognized inherent delta volume. This updating operation is referred to as a filling operation. The filling operation is executed by calculating a union of the profile of the part and the recognized inherent delta volume.

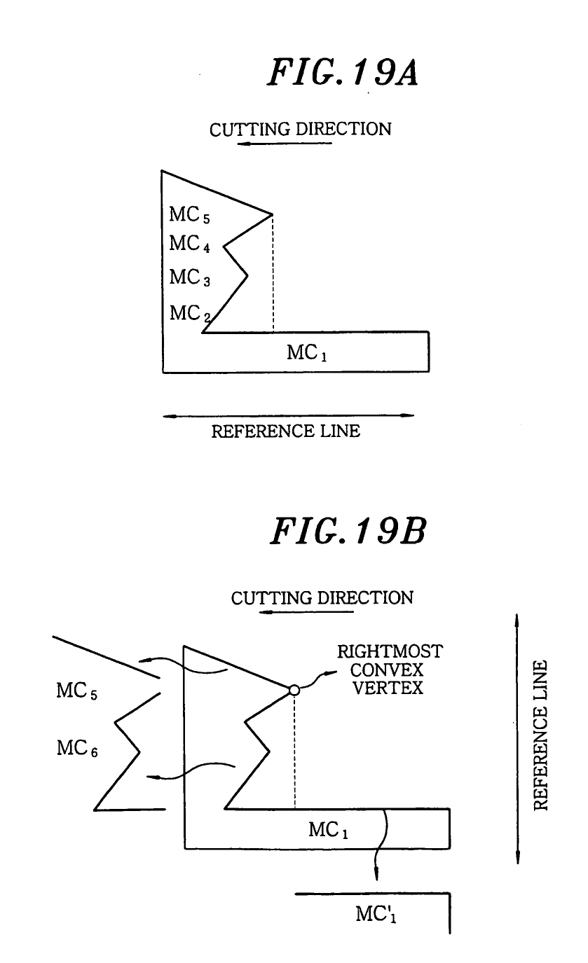

Step 3: A reference line is determined for the updated input profile such that the number of monotone chains for the reference line is minimized. If non-monotone segments are found among the monotone chains, the non-monotone segments are processed by using a method in accordance with the present invention, which will be described later with reference to FIGS. 19A and 19B.

Step 4: A stitch operation is performed for the monotone chains obtained in the step 3. That is, consecutively positioned monotone chains are connected, such that a maximum monotone chain is obtained.

Step 5: A first turning tool is selected for the maximum monotone chain. And then, based on the first turning tool, a primary delta volume and an uncut delta volume are determined for the maximum monotone chain.

Step 6: A second turning tool is selected for the uncut delta volume obtained in the step 5. The step 5 is performed once again for the uncut delta volume and the second turning tool. In this case, when a profile of the uncut delta volume is a completely monotone chain, it is preferable that (i) the second turning tool has a smaller insert angle, i.e., a larger FMR, than the turning tool selected for the primary delta volume or (ii) the second turning tool has an inverse cutting direction with respect to that of the turning tool selected for the primary delta volume. Further, when a profile of the uncut delta volume is a monotone chain having a line segment perpendicular to a horizontal line, it is preferable that (i) the second turning tool has a grooving insert or (ii) the second turning tool has an inverse cutting direction with respect to that of the turning tool selected for the primary delta volume.

Step 7: After the step 6 is performed, if another uncut delta volume is found, the uncut delta volume is set as a simple delta volume. And then, a turning tool suitable for the simple delta volume is selected.

FIGS. 19A and 19B show a method for processing a non-monotone segment, which is generated in the step 3 of the method for decomposing a delta volume in accordance with the present invention. Among the monotone chains obtained in the step 3, monotone chains having less than 2 segments become non-monotone segments. A profile (represented as thick solid lines) of a part shown in FIG. 19A is divided into 5 monotone chains MC₁ to MC₅, whose reference line is a horizontal line. Herein, if it is assumed that the monotone chains MC₁ and MC₅ consist of more than one segments, the remaining monotone chains MC₂, MC₃ and MC₄ become non-monotone segments.

The non-monotone segments MC₂, MC₃ and MC₄ are processed as follows: First, as shown in FIG. 19B, when a vertical line perpendicular to a reference line is drawn from a rightmost convex vertex of the non-monotone segments MC₂, MC₃ and MC₄, a point where the vertical line and the reference line cross is set as a new left end point of the monotone chain MC₁. And then, as shown in FIG. 19B, a new reference line is determined such that the non-monotone segments including a left-hand part of the monotone MC₁ are monotone to the new reference line. In this case, if such a new reference line cannot be determined, a profile is corresponding to the non-monotone segments is considered to be uncuttable by using any turning tool. For the monotone chains obtained by using the method described above with reference to FIGS. 19A and 19B, the steps 4 to 7 of the method for decomposing a delta volume in accordance with the present invention are performed. Herein, it should be noted that the maximum monotone chain obtained in the step 4 does not include the monotone chains obtained by using the method described above with reference to FIGS. 19A and 19B.

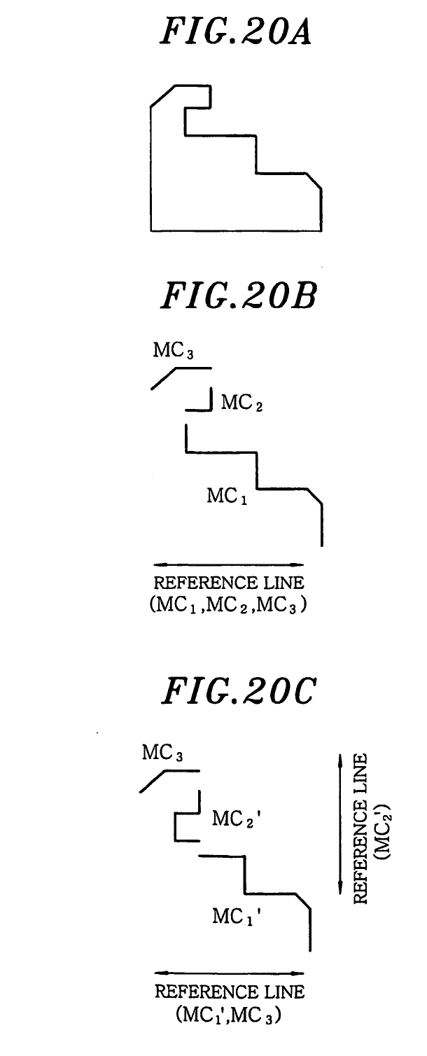

FIGS. 20A to 20C chart a process of decomposing a delta volume for a part in according with the present invention. FIG. 20A illustrates an exemplary finished part, and FIG. 20B shows a result of performing thereon the step 3 of the method for decomposing a delta volume in accordance with the present invention. FIG. 20C describes a result of processing a monotone chain MC₂ including non-monotone segments by using the method described above with reference to FIGS. 19A and 19B. Herein, since MC′₂ is not taken into a consideration in determining a maximal monotone chain in the step 3, it is understood that the result of delta volume composition shown in FIG. 20C is identical with that of delta volume composition shown in FIG. 20B.

Even though the method for delta volume decomposition in accordance with the present invention is described as for a case when applied in an outer contouring, the method of the present invention can also be applied in an inner contouring. The only information needed to perform the method for delta volume decomposition in accordance with the present invention is the information on an insert to be used in contouring. Information on a holder, where the insert is to be equipped, is only used in determining whether or not delta volumes obtained by using the method of the present invention are to be contoured by using the insert. Only difference between the outer contouring and the inner contouring is that a direction of the holder used in the inner contouring is parallel to the Z axis of the turning coordinates.

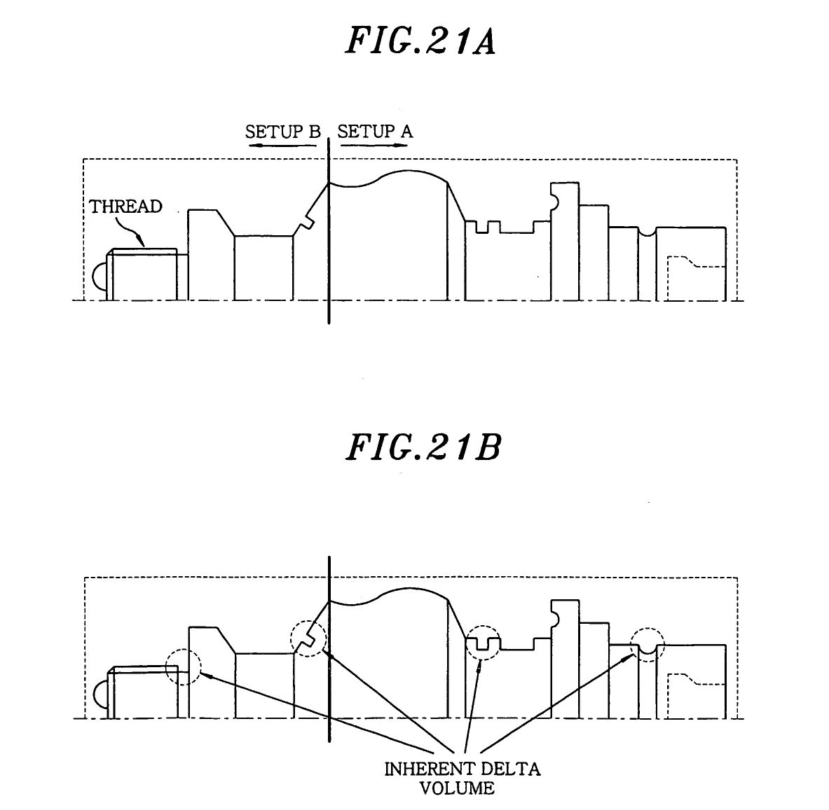

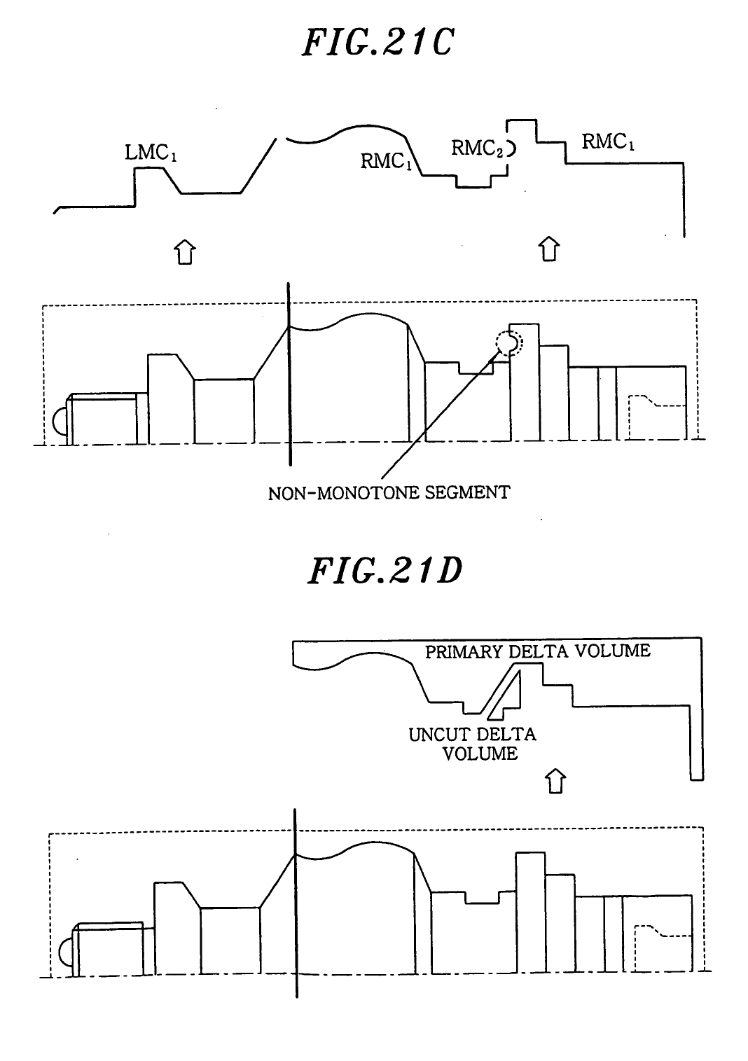

FIGS. 21A to 21D depict a process of decomposing a delta volume for a complicated part in accordance with the present invention. First, a profile of a finished part shown in FIG. 21A is divided into two segments in accordance with setups A and B. Next, as shown in FIG. 21B, inherent delta volumes are determined for each of the setups A and B. And then, as shown in FIG. 21C, an input profile is updated through a filling operation; monotone chains are determined based on the updated input profile; a simple delta volume is determined based on non-monotone segments; and a maximum monotone chain is calculated through a stitch operation. Finally, as shown in FIG. 21D, a primary delta volume and an uncut delta volume is determined based on the maximum monotone chain.

In the meantime, as shown in FIG. 22, there are dependencies between delta volumes obtained by using the method for delta volume decomposition in accordance with the present invention. In FIG. 22, a secondary delta volume means an uncut delta volume. Therefore, the secondary delta volume must be cut away after cutting a primary delta volume. Further, an inherent delta volume must be cut away after cutting a primary delta volume or both a primary delta volume and a secondary delta volume:

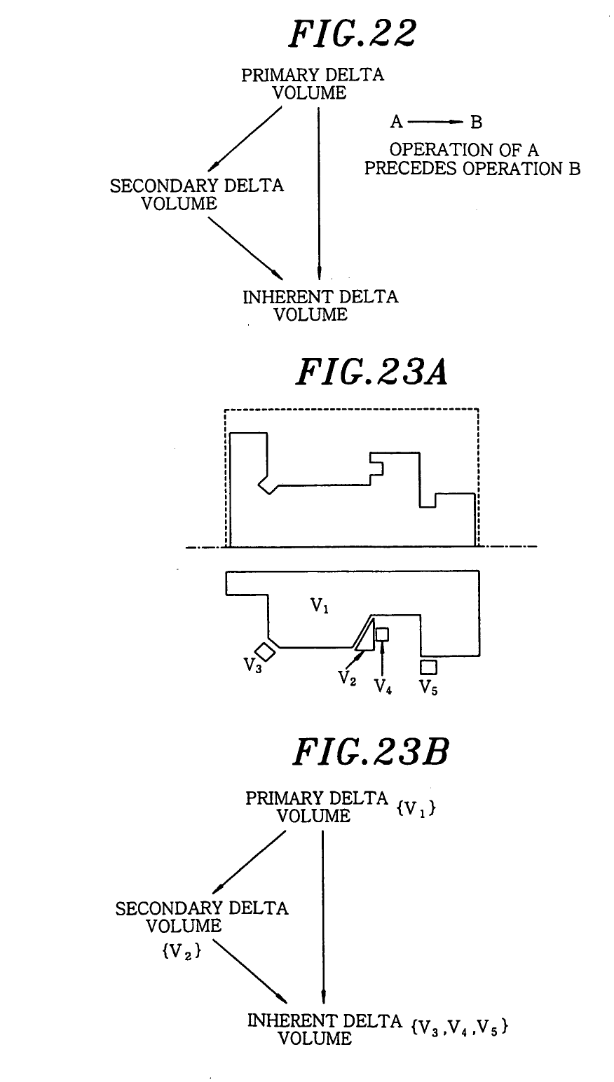

FIG. 23A illustrates a part and delta volumes therefor calculated by using the method for delta volume decomposition in accordance with the present invention, and FIG. 23B sets forth a dependency graph showing dependencies between the delta volumes shown in FIG. 23A. The dependency graph shown in FIG. 23B can also be represented as a dependency graph shown in FIG. 24, which exhibits in detail a relation between a secondary delta volume and an inherent delta volume. As shown in FIG. 24, an inherent delta volume V₄ must be cut away after a secondary delta volume V₂, but inherent delta volumes V₃ and V₅ must be cut away after a primary delta volume V₁ regardless of whether or not the secondary delta volume V₂ is cut away. However, it is preferable that all of inherent delta volumes are cut with an identical turning tool. Moreover, it is preferable that all the inherent delta volumes are cut away after a secondary delta volume is cut, which results in an increased turning efficiency since the number of exchanging turning tools in the actual turning process decreases. Such a dependency between an inherent delta volume and a secondary delta volume, which is set for the turning efficiency, is referred to as an auxiliary dependency.

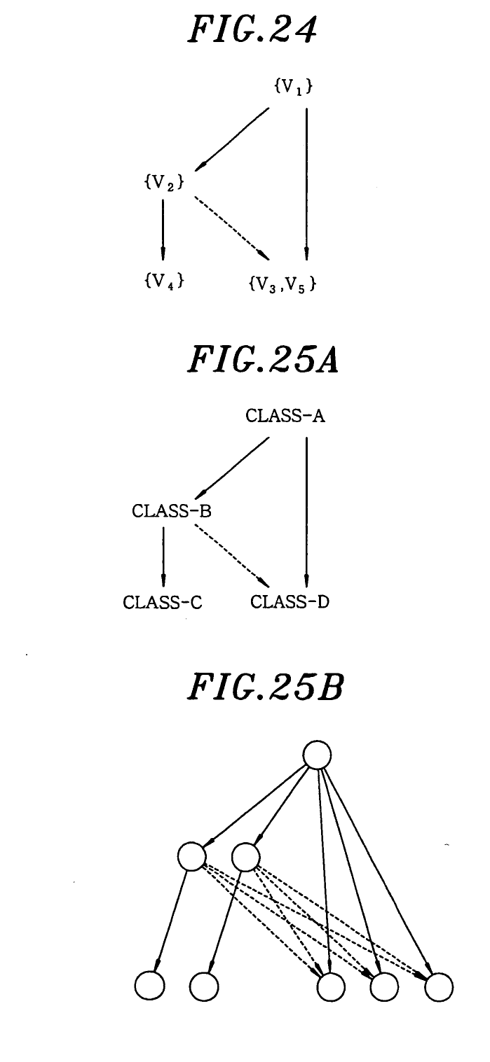

FIGS. 25A and 25B describe exemplary dependency graphs including an auxiliary dependency defined in accordance with the present invention. For the sake of explanation, a primary delta volume, a secondary delta volume, an inherent delta volume which must be cut away after a secondary delta volume is cut, and an inherent delta volume having an auxiliary dependency on a secondary delta volume are assumed to belong to classes A, B, C and D, respectively (refer to FIG. 25A). Herein, an inherent delta volume may belong to the class C or D.

An auxiliary dependency between delta volumes can be found as follows. First, to each of all segments comprising a profile of a delta volume is assigned one of properties A, B and C. That is, to a segment belonging to a profile of a finished part is assigned the property A; to a segment belonging to a profile of a primary delta volume is assigned the property B; and to a segment belonging to a profile of a secondary delta volume is assigned the property C. Herein, if a segment having the property C also belongs to a profile of an inherent delta volume, the segment belongs to the class C. On the other hand, if a segment having the property C does not belong to a profile of an inherent delta volume, the segment belongs to the class D.

Meanwhile, delta volumes belonging to a same class have no precedence relation therebetween, but delta volumes belonging to different classes have a precedence relation therebetween. Accordingly, a dependency graph can be represented by using delta volumes but not by using classes to which the delta volumes belong. FIG. 25B shows an example of a dependency graph represented by using delta volumes.

Hereinafter, a method for generating a PSG (process sequence graph) based on the above-described concept of the dependency graph will be explained.

The PSG is a graph showing an ordered list of turning operations, wherein a node included in the PSG represents the type of an operation or an operational relation between operations, and an arc connecting the nodes represents a precedence relation between the operations. The operational relation between operations may be one of three types: AND (non-sequential relation), OR (selective relation) and PARALLEL relation. Since a dependency graph of delta volumes shows dependencies between the delta volumes, i.e., precedence relations therebetween, a PSG can be determined directly from the dependency graph. The conversion of a dependency graph to a PSG includes the steps of: (i) assigning one of operational relations AND, OR and PARALLEL to each node in the PSG; and (ii) specifying information on an operation corresponding to the node.

The assignment of an operational relation to a node in a PSG is executed as follows.

Firstly, the AND relation is assigned to a node corresponding to an operation for delta volumes belonging to a same class. As described above, since there is no precedence relation between delta volumes belonging to a same class, the AND relation can be set only between operations for delta volumes belonging to a same node. An operational relation between operations for delta volumes belonging to different classes may be set by using an arc connecting nodes, wherein each of the operations belongs to a different node.

Secondly, the OR relation corresponds to an auxiliary dependency of a dependency graph. In general, the OR relation is used in representing a relation between operations which can be exchangeable with each other. This relation is applied for a case of (i) decomposing delta volumes in a different way or (ii) setting the sequence of operations of delta volumes in a different way. In accordance with the present invention, the result of delta volume decomposition is fixed depending on a selected turning tool and a finished part. Further, one type of a turning tool is used in machining one delta volume regardless of whether the turning tool is selected by a manufacturing engineer or based on a reference line of a monotone chain corresponding to a profile of the delta volume. Accordingly, in the present invention, the OR operation represents only the setting of the sequence of operations of delta volumes in a different way.

Thirdly, the PARALLEL relation represents a case where a primary delta volume is cut concurrently by using two turning tools, each of which is equipped in one of two turrets of a turning machine.

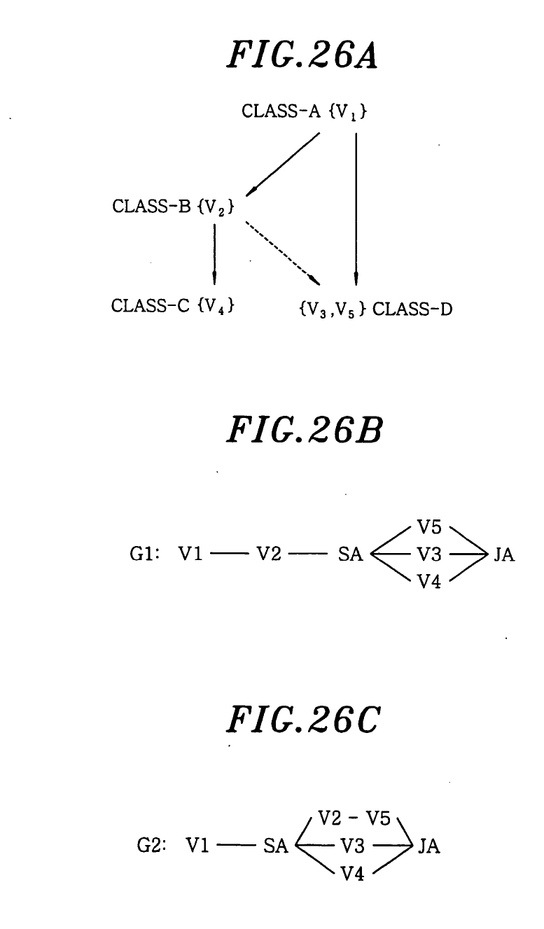

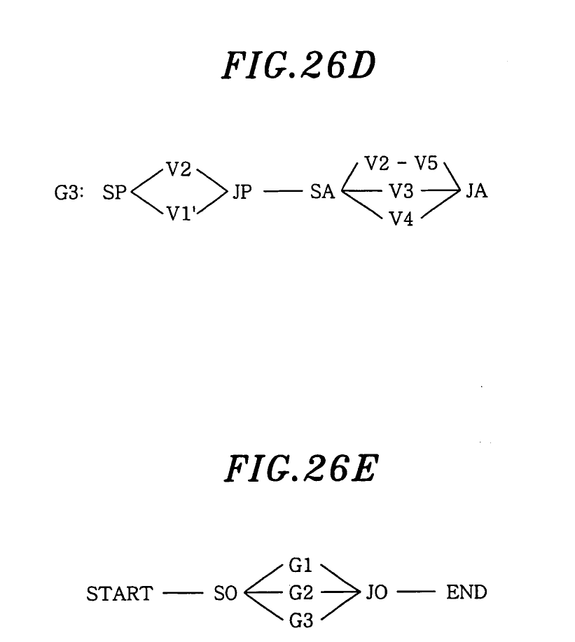

FIGS. 26A to 26E show an exemplary dependency graph and non-linear PSGs generated based on the dependency graph. The PSGs shown in FIGS. 26B to 26E are generated by applying one of AND, OR and PARALLEL relations to each node of the dependency graph shown in FIG. 26A.

For the sake of explanation, the PSGs shown in FIGS. 26B to 26D are referred to as type-1, type-2 and type-3 PSGs, respectively. The type-1 PSG shown in FIG. 26B represents a case where delta volumes are machined in an order of {class-A}→{class-A}→{class-C, class-D}. In this case, there is no precedence relation between the classes C and D. Further, all delta volumes belonging to the classes C and D must be cut away after a delta volume belonging to the class B is cut. Accordingly, it is understood that the type-1 PSG shown in FIG. 26B represents an auxiliary dependency included in the dependency graph shown in FIG. 26A. On the contrary, the type-2 PSG shown in FIG. 26C does not reflect the auxiliary dependency shown in FIG. 26A. Meanwhile, the type-3 PSG shown in FIG. 26D represents a case where a primary delta volume is cut concurrently by using two turning tools equipped in a turning machine.

The concurrent operations in a turning machine occur in two cases: (i) a case where two turning tools cut concurrently one delta volume and (ii) a case where each of two turning tools cuts concurrently a different delta volume. In the present invention, such a concurrent operation is accomplished by (i) subdividing a profile of a finished part based on a machine configuration during a procedure of delta volume decomposition or (ii) cutting concurrently a primary delta volume represented in a type-3 PSG by using two turning tools.

Meanwhile, a PSG includes only basic information on a concurrent operation but not other information, e.g., information on which turning tool is used in cutting a delta volume or when the delta volume is cut. Accordingly, a method for representing detailed information on the concurrent operation, which is not represented by using a PSG, is needed.

In the following, a method for determining an ordered list of concurrent turning operations in accordance with present invention will be described in detail.

In the present invention, a concurrent turning operation, where one delta volume is cut concurrently by using two turning tools, is taken into consideration only when it is represented by a PSG. Therefore, the method for determining an ordered list of concurrent turning operations in accordance with the present invention is performed only for a case where different delta volumes are cut concurrently by using two turning tools. Since delta volumes except a primary delta volume are small, and there are few precedence relations between the delta volumes, it is more efficient to consider a case where different delta volumes are cut concurrently by using two turning tools. Further, it is preferable that an ordered list of concurrent turning operations is determined based on emergency situations, generated tool paths, etc.

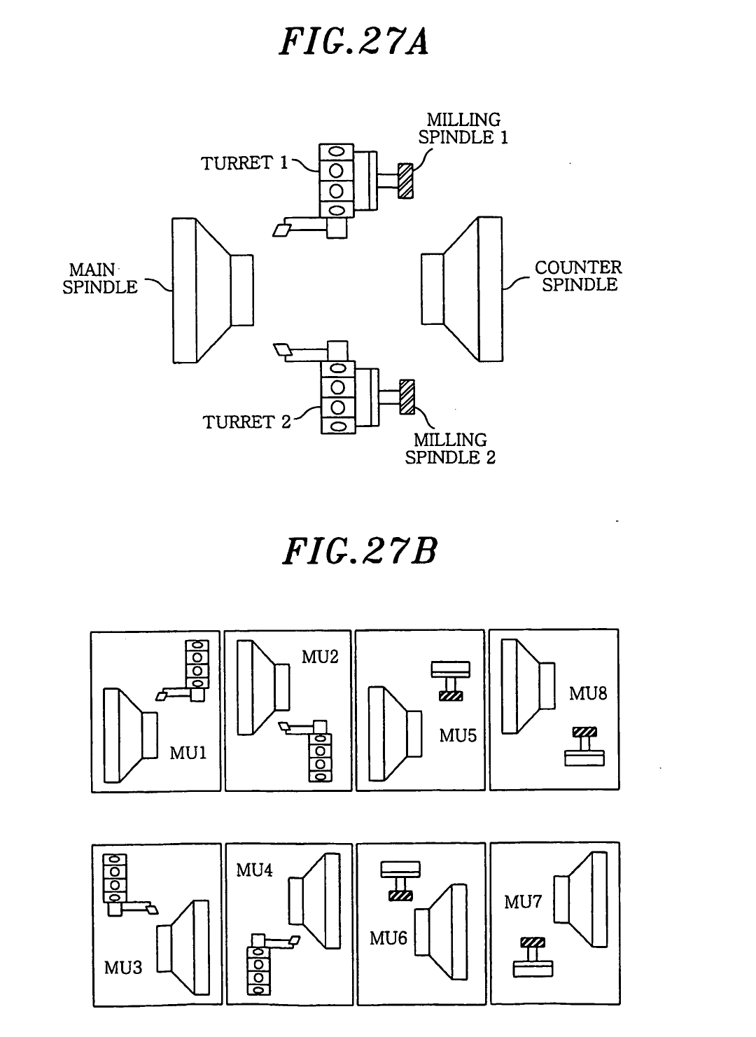

FIGS. 27A and 27B depict an example of a parallel mill/turn machining center and MUs (machining units) included therein, respectively. The determination of an ordered list of concurrent turning operations can be accomplished by assigning each of operations represented by using nodes of a PSG to a corresponding MU included in a turning machine. A heuristic method for assigning an operation represented by using a PSG to a MU now will be described in detail.

An operation represented by using a PSG may be assigned to an MU included in a turning machine by performing the steps of: (1) setting T to zero, wherein T is a current point of time; (2) selecting a certain initial setup of the turning machine; (3) selecting currently available MUs in the turning machine and adding the selected MUs to AMU(T), wherein AMU(T) is a set of MUs available at a point of time T; (4) searching for operations in the PSGs, which are currently executable, and adding the operations to NOP(T), wherein NOP(T) is a set of operations executable at a point of time T; (5) based on OSR, selecting an operation OP among the operations belonging to NOP(T), wherein the OSR is a rule for selecting an operation; (6) based on MSR, selecting an MU M among the MUs belonging to AMU(T) and adding the selected MU M to RMU(T), wherein the MSR is a rule for selecting an MU and RMU(T) is a set of MUs operating at a point of time T; (7) deleting M from AMU(T) and deleting OP from NOP(T); (8) if AMU(T) is not empty, repeating the steps 3 to 7; (9) if AMU(T) is empty, adding min{tⱼ:jεRMU(T)} to T, wherein tⱼ is time consumed in processing an operation j; and (10) if all operations are completely processed, terminating the whole process, and if otherwise, repeating to the steps 4 to 10.

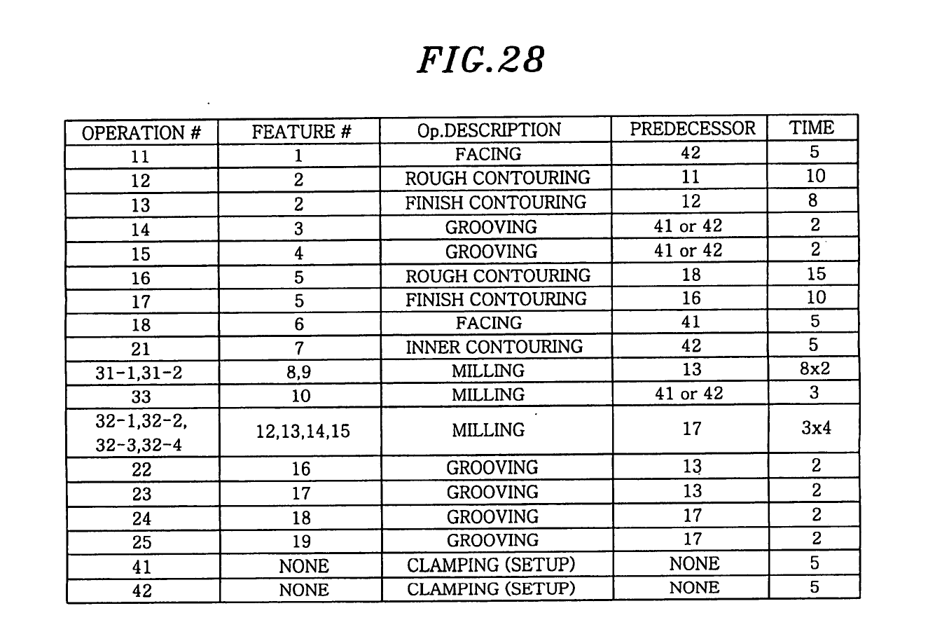

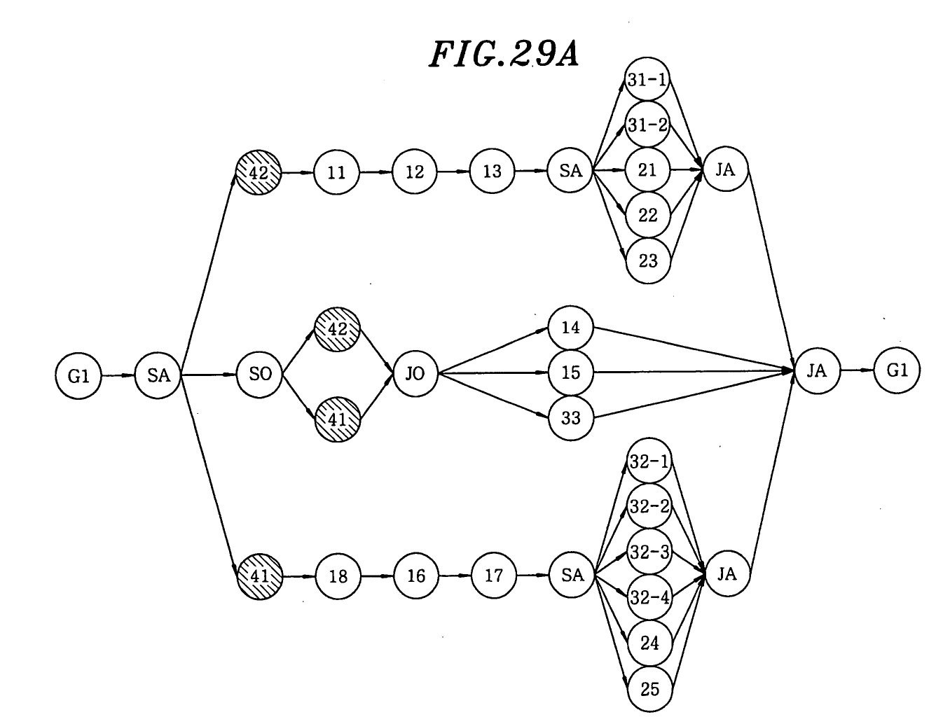

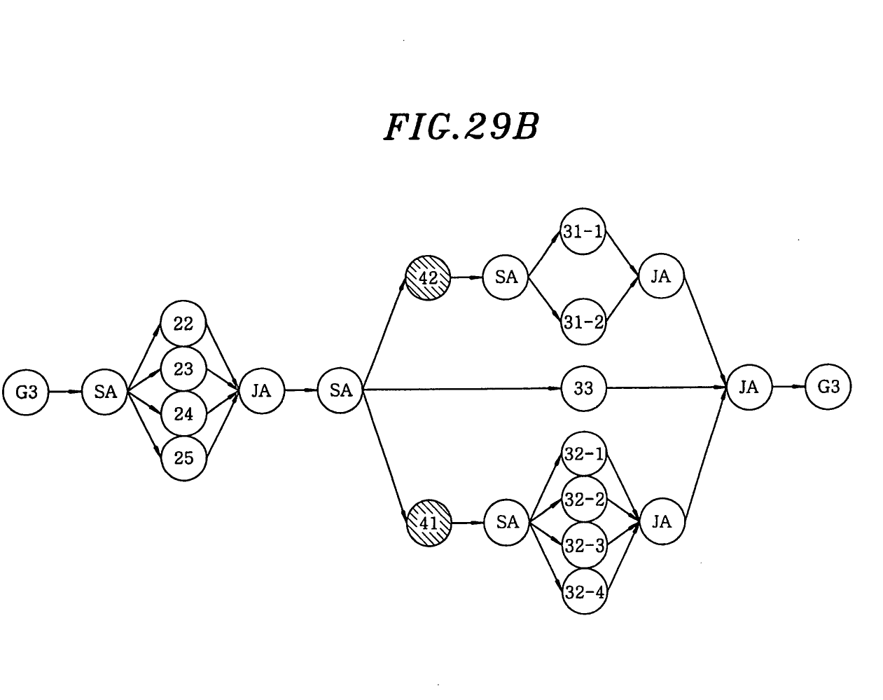

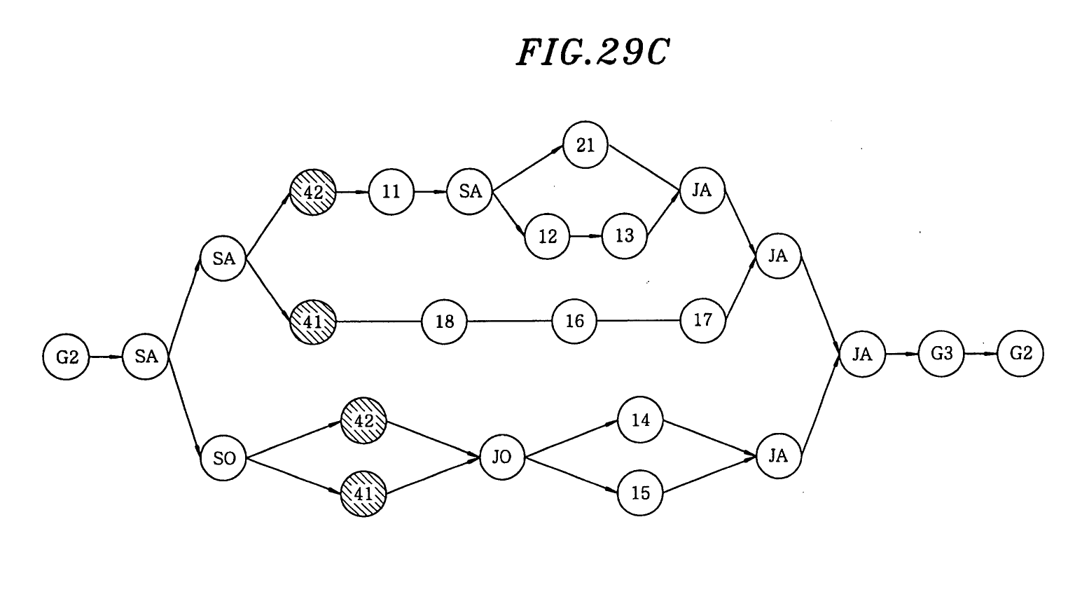

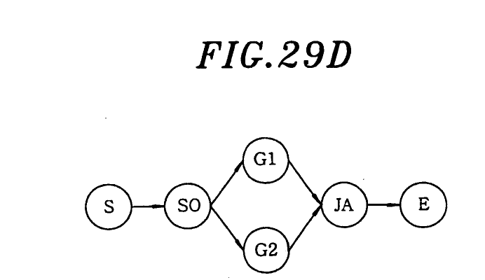

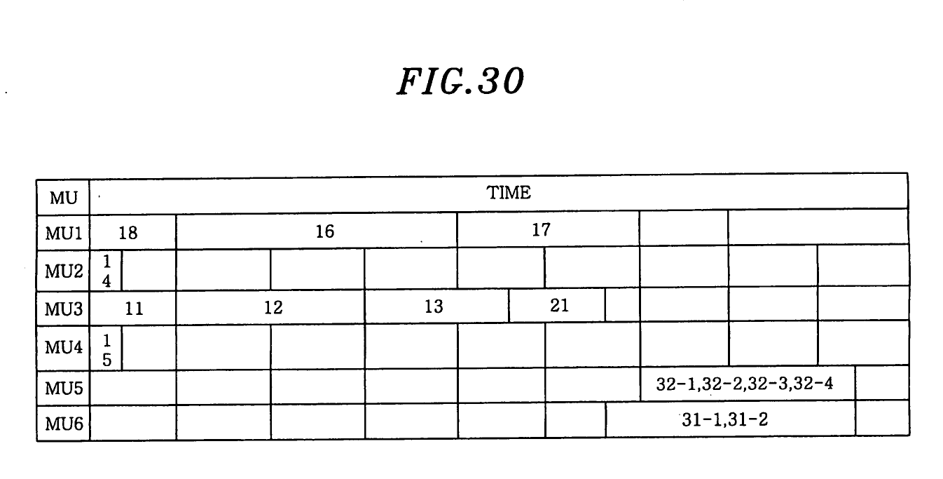

For example, when PSGs are generated as shown in FIGS. 29A to 29D for the turning machine shown in FIGS. 27A and 27B, a table showing an ordered list of concurrent operations as shown in FIG. 30 can be obtained by using the heuristic method for determining an ordered list of the concurrent operations based on information on operations shown in FIG. 28 in accordance with present invention.

The above-described method of the present invention may be applied in a rough contouring or a finish contouring. In general, a rough contouring needs to be performed independently from a finish contouring. If needed, a secondary finish contouring is further required to satisfy a tolerance and a surface roughness noted on a drawing. A typical turning process proceeds in order of a rough contouring, a finish contouring and a measurement of a tolerance and a surface roughness followed by a secondary contouring.

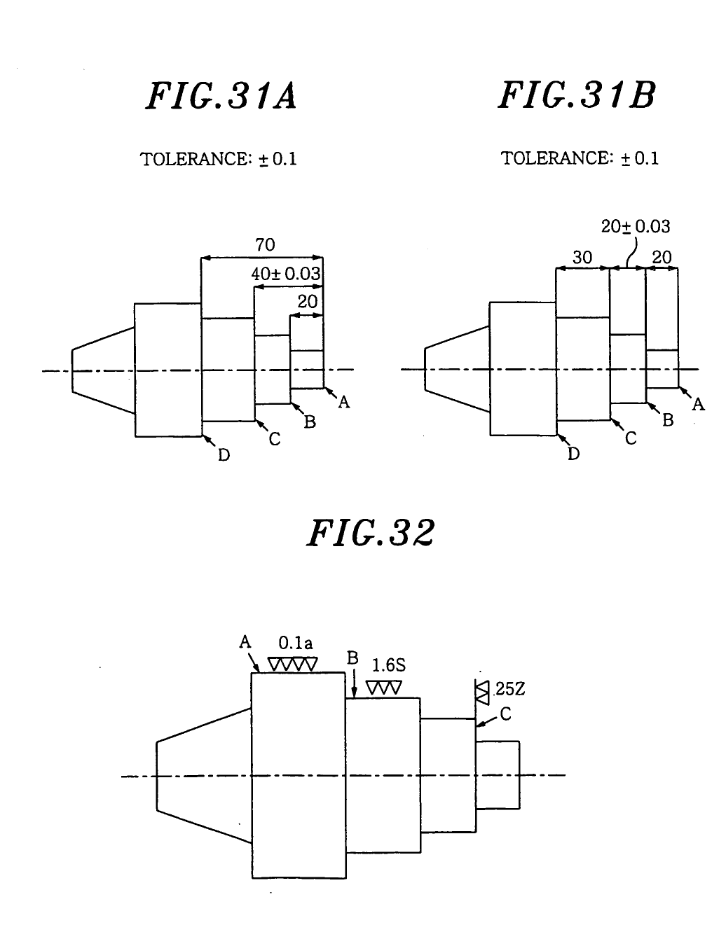

As shown in FIGS. 31A and 31B, tolerances can be represented by using two types of notations on a drawing. As shown in FIG. 31A, when a surface A represents a reference surface, surfaces A and C are required to be cut precisely. Such surfaces like as the surfaces A and C are referred to as significant surfaces. The finished part shown in FIG. 31A may be cut as follows: First, surfaces A, B, C and D are roughly contoured with a margin of 0.5. Then, the surfaces A, B and D are finely contoured with no margin, and the surface C is finely contoured with a margin of 0.2. Thereafter, a length A-C is measured, thereby determining an amount of additional contouring based thereon. Finally, based on the amount of additional contouring, a secondary finish contouring is performed on the surface C. For a finished part shown in FIG. 31B, the above described process can also be applied. In FIG. 31B, surfaces B and C are significant surfaces.

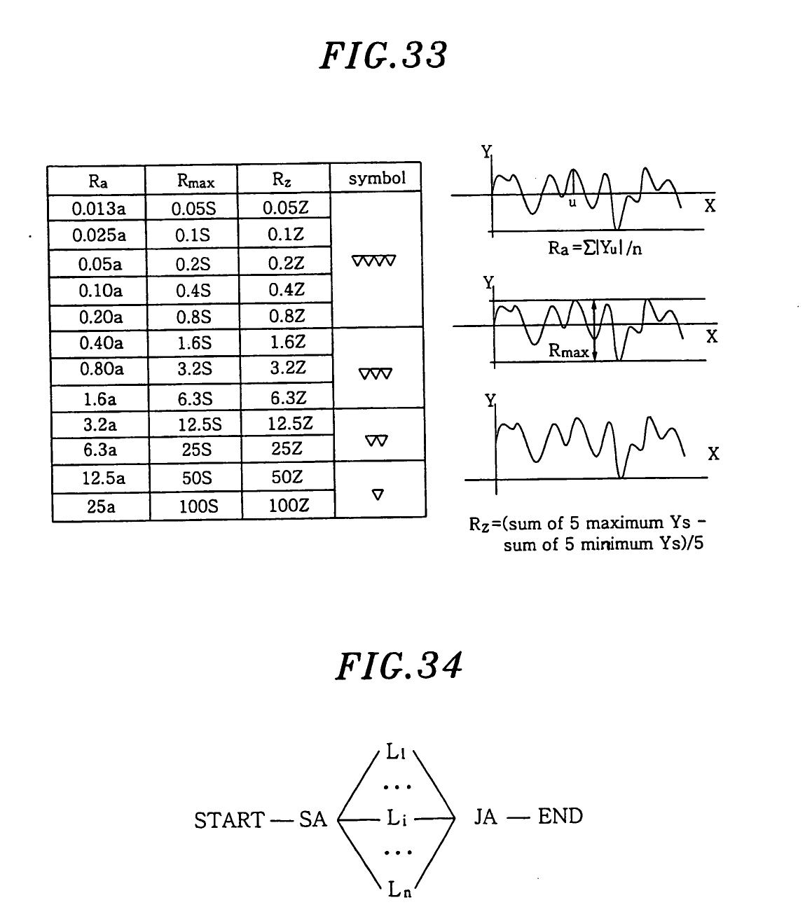

FIG. 32 describes notations of surface roughness on a drawing for use in turning. The surface roughness may be calculated by averaging the values of Rₐ, Rₘₐₓ or R_{z}, which are sampled randomly on a surface of a finished part. FIG. 33 charts sampled values of surface roughness and graphs related thereto. As shown in FIG. 33, the surface roughness. is represented by using triangle symbols, i.e., roughness symbols. Depending on a surface roughness represented by a triangle symbol, a secondary finish contouring may be performed on a surface after a rough contouring and/or a finish contouring is performed thereon.

In the following, a method for generating a PSG for a secondary finish contouring based on a tolerance and a surface roughness in accordance with the present invention will be described in detail. The method for generating a PSG for a secondary finish contouring based on a tolerance and a surface roughness includes the steps of: (1) determining a significant, surface; (2) selecting a turning tool for each of the surfaces belonging to the sets S_{T} and S_{F}, wherein S_{T} is a set of surfaces related to a tolerance and S_{F} is a set of surfaces related to a surface roughness; (3) assigning surfaces to be cut by using a same turning tool to a certain group, wherein S₁, S₂, . . . , Sₙ are groups to be cut by using 1, 2, . . . , n turning tools, respectively; (4) determining an ordered list Lᵢ of operations to be performed on each of the surfaces belonging to set Sᵢ; and (5) setting AND relations between the operations belonging to the set Lᵢ. FIG. 34 shows an exemplary non-linear PSG generated by using the above-described method for generating a PSG for a secondary finish contouring based on a tolerance and a surface roughness.

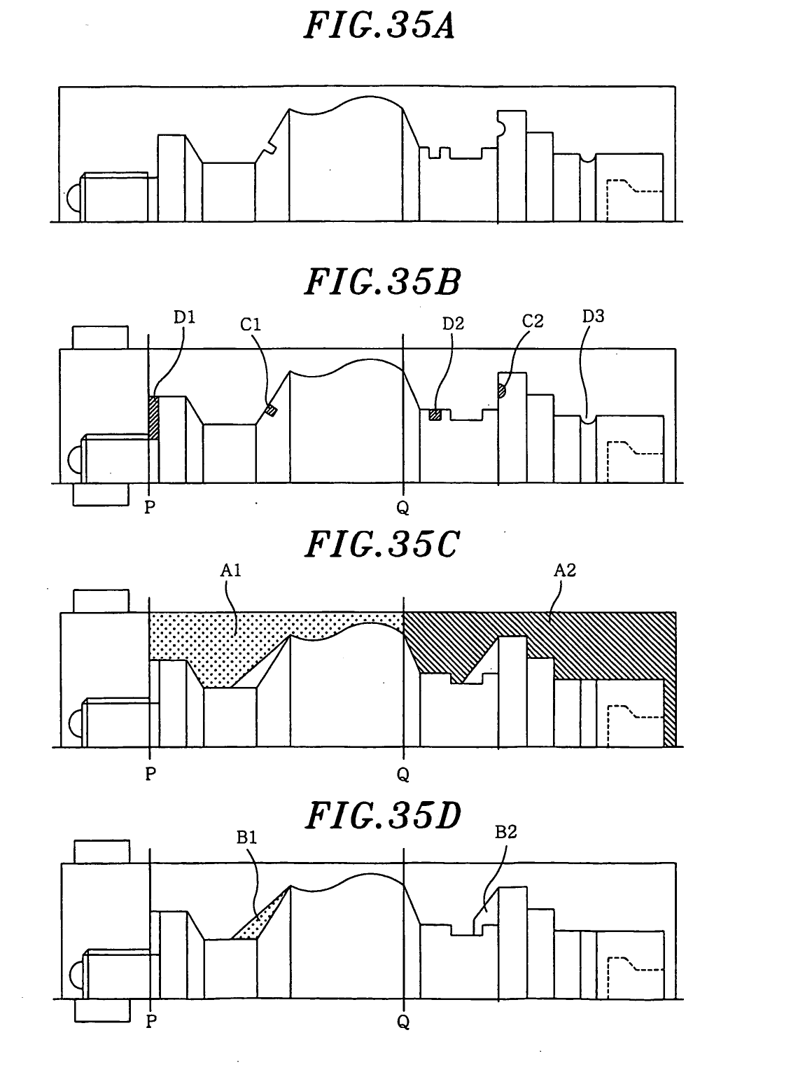

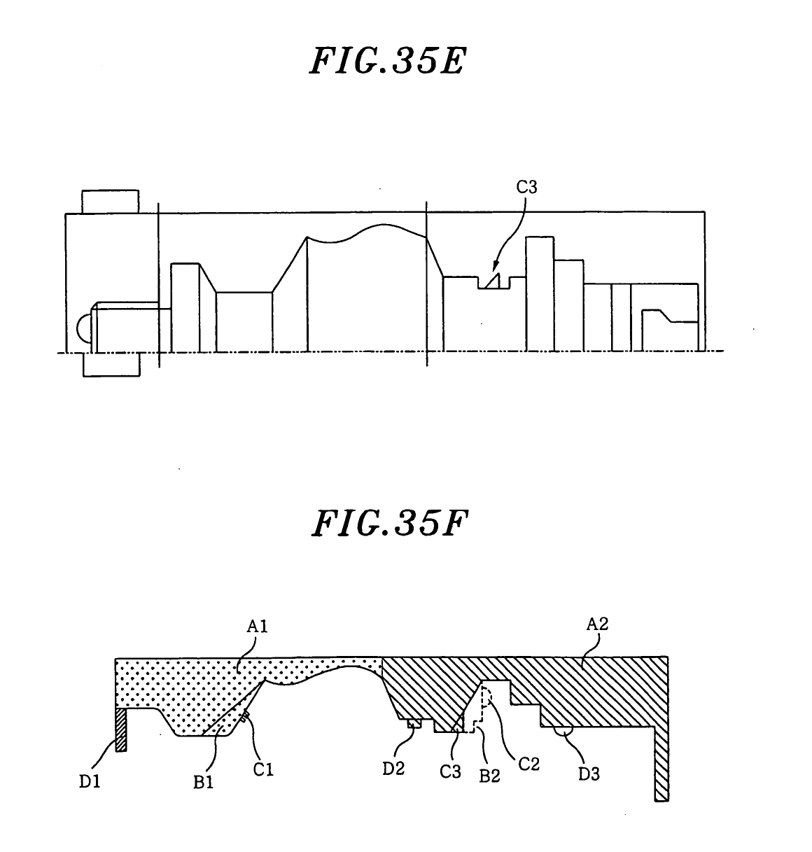

Hereinafter, examples of PSGs generated for a more complicated finished part will be explained. FIGS. 35A to 35F depict the steps of the method for performing a delta volume decomposition in accordance with the present invention.

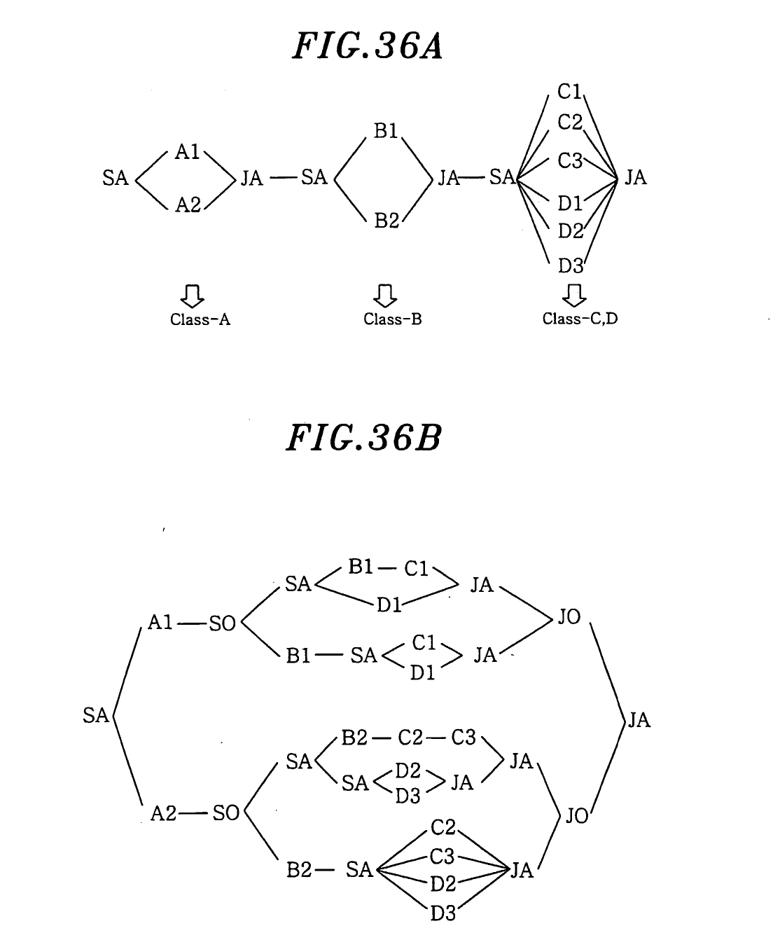

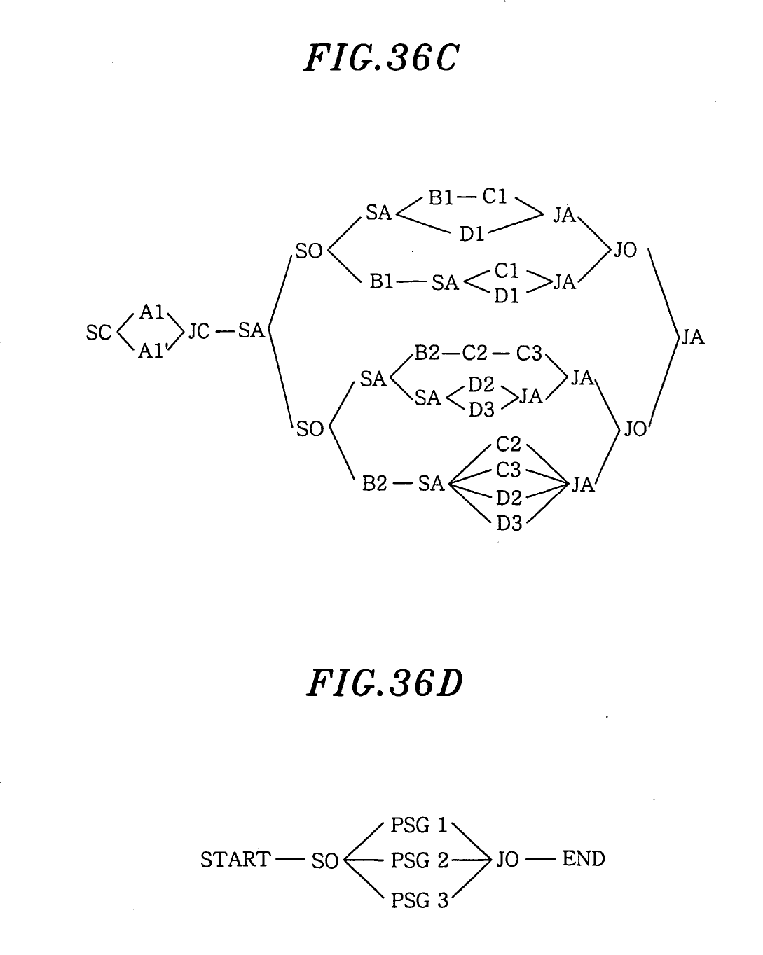

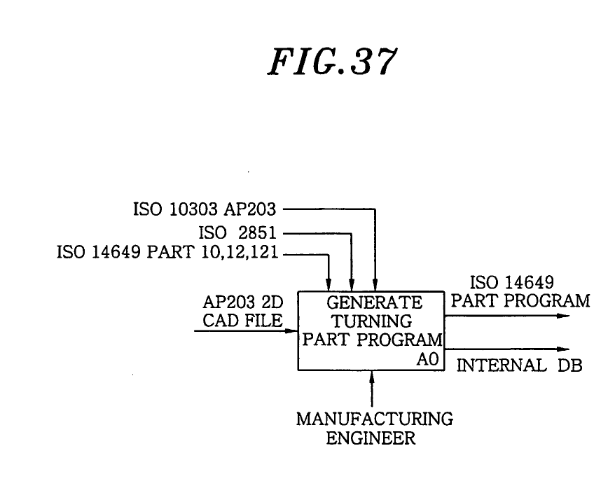

FIG. 35A shows an upper-half profile of a complicated finished part. First, a part to be machined in a current setup is determined. For the finished part shown in FIG. 35A, as show in FIG. 35B, a part right to a vertical line P is assumed to be a part to be machined in a current setup. If two turrets are to be used in cutting concurrently the part, the part is divided into two delta volumes by a vertical line Q as shown in FIG. 35B. Thereafter, for each of the delta volumes, inherent delta volumes C₁, C₂, D₁, C₂ and D₃ are recognized, and an input profile is updated by using the inherent delta volumes. And then, as shown in FIG. 35C, a maximum monotone chain is determined, and primary delta volumes A₁ and A₂ are determined for the maximum monotone chain. Next, as shown in FIG. 35D, uncut delta volumes B₁ and B₂ are determined. In this case, as shown in FIG. 35E, another uncut delta volume C₃ may be generated. FIG. 35F indicates that a sum (A₁+A₂+B₁+B₂+C₁+C₂+C₃+D₁+D₂+D₃) of all delta volumes determined through the steps shown in FIGS. 35B to 35E is equal to a delta volume to be cut away from a raw stock to obtain the finished part. FIGS. 36A to 36C chart type-1, type-2 and type-3 PSGs, which are generated based on a dependency graph generated by using the results of delta volume decomposition shown in FIG. 35F. Further, FIG. 36D illustrates an aggregate PSG, which is a sum of all PSGs shown in FIGS. 36A to 36C.

FIGS. 37 to 43 describe IDEF-0 diagrams representing an operational scenario for a turning SFP (shop-floor programming) system, which is generated by using the method for delta volume decomposition and process planning in accordance with the present invention. Herein, the IDEF (Integration DEFinition) means a language for modeling an SFP system, and the IDEF-0 is a part of the IDEF for modeling functional aspects of an SFP system.

FIG. 37 exhibits a system for automatically generating process plans based on the results of delta volume decomposition in accordance with the present invention. As shown in FIG. 37, a turning SFP system A0 inputs an AP203 2D CAD file and generates an ISO 14649 part program and/or an internal DB for a controller where the turning SFP system is equipped.

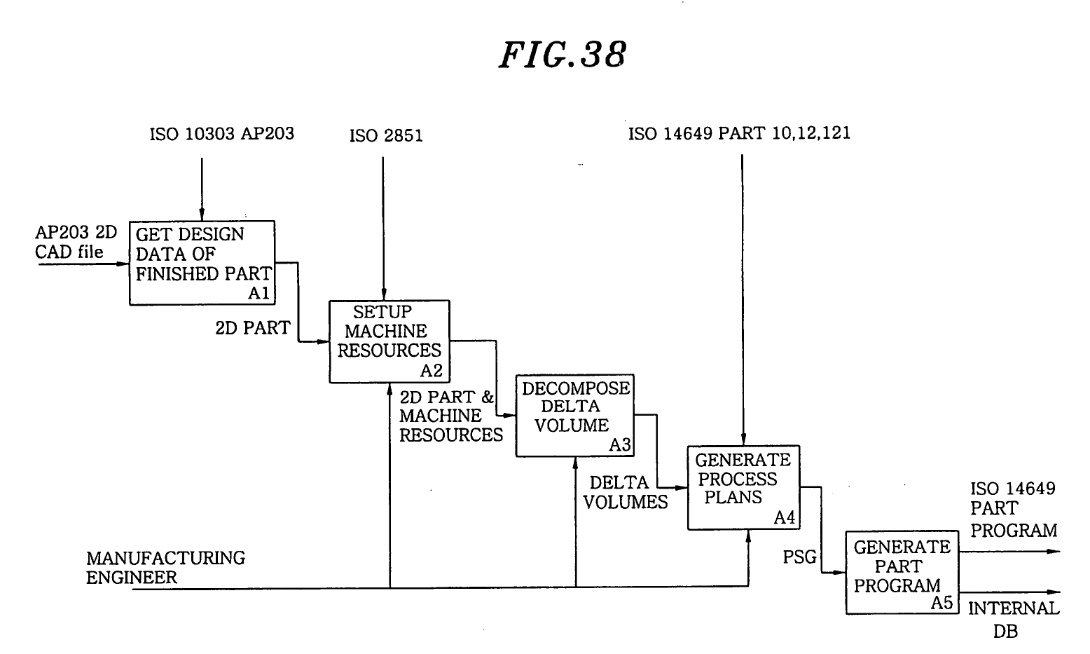

FIG. 38 illustrates components of the system A0 shown in FIG. 37. First, the turning SFP system A0 inputs an AP203 2D CAD file and obtains design data of a finished part (block A1). Next, based on the design data of the finished part, machine resources are determined (block A2). And then, based on the design data of the finished part and the machine resources, delta volume decomposition is performed (block A3). Subsequently, based on the results of the delta volume decomposition, process plans (PSGs) are generated (block A4). Finally, a part program is generated based on the PSGs (block A5).

In the following, each of the blocks A1 to A5 shown in FIG. 38 will be described in detail.

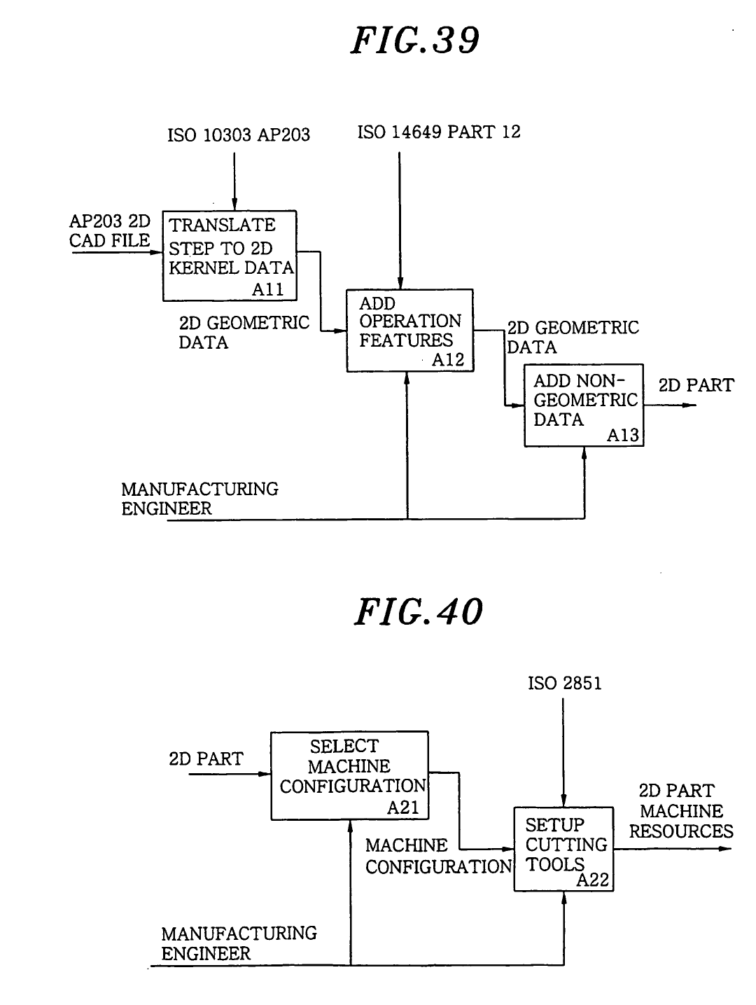

FIG. 39 shows a block diagram showing a process of analyzing CAD data, which is a detailed diagram of the block A1 shown in FIG. 38. In the block A1, first, the inputted AP203 2D CAD file including geometry information on a raw stock and a finished part is converted into an internal geometry data (block A11). Next, operation features are added to the internal geometry data (block A12). Thereafter, non-geometric data, i.e., values of a tolerance and a surface roughness are added thereto (block A13). Herein, the operation features mean features such as a thread and knurl, which is to be machined by using a dedicated turning tool after the parts recognized during the delta volume decomposition.

FIG. 40 explains a block diagram showing a process of considering a machine configuration, which is a detailed diagram of the block A2 shown in FIG. 38. In the block A2, first, a machine configuration is selected (block A21), and then, cutting tools are setup (block A22). To put it in detail, in the block A21, based on the inputted geometry information on the finished part, a configuration of a turning machine to be used in cutting the finished part is selected. Thereafter, in the block A22, based on the selected machine configuration, cutting tools are selected from a tool DB and it is determined how the selected cutting tools are equipped in a turret. Herein, the tool DB is readily prepared by storing tool information in accordance with ISO 2851 for defining standards for a tool holder and a tool insert. FMRs of the cutting tools are calculated in accordance with ISO 2851.

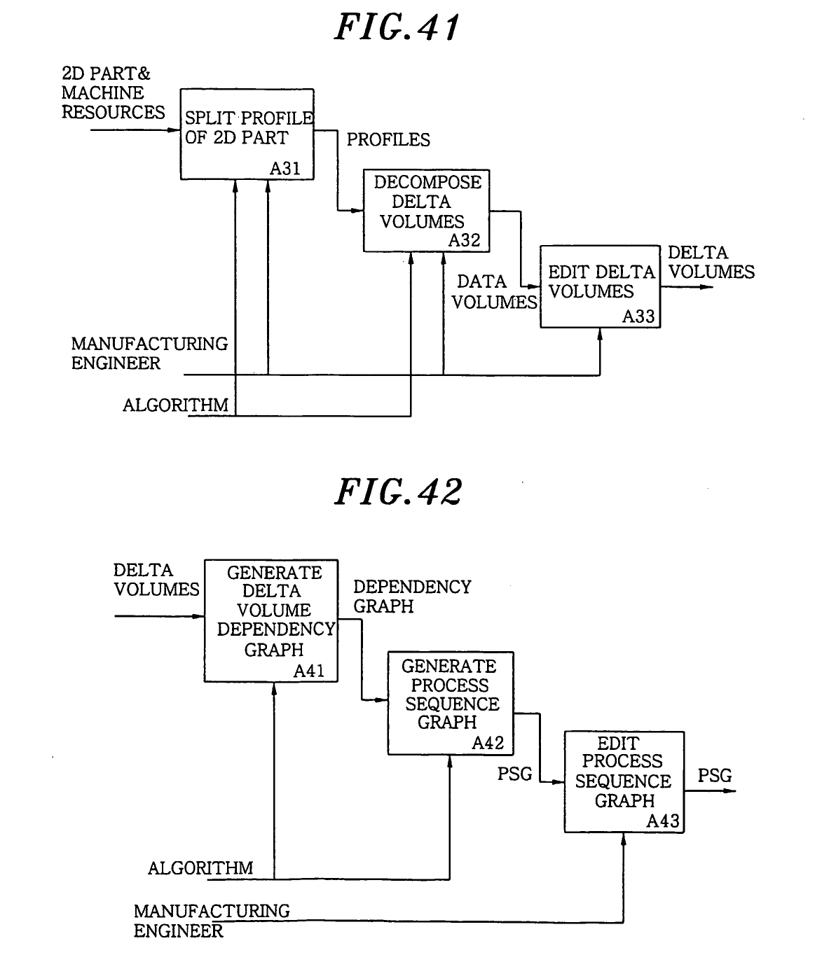

FIG. 41 shows a block diagram showing a process of decomposing a delta volume, which is a detailed diagram of the block A3 shown in FIG. 38. In the block A3, based on the inputted machine configuration and geometry information on the raw stock and the finished part, a location of a split of a profile of the finished part is determined (block A31). And then, based on information on each of the split profiles, delta volume decomposition is performed (block A32). Finally, the decomposed delta volumes may be edited (block A33).

FIG. 42 shows a block diagram showing a process of generating a non-linear PSG, which is a detailed diagram of the block A4 shown in FIG. 38. In the block A4, first, a dependency graph is generated based on the results of the delta volume decomposition (block A41). Next, PSGs are generated based on the generated dependency graph (block A42). Finally, the PSGs may be edited as needed (block A43)

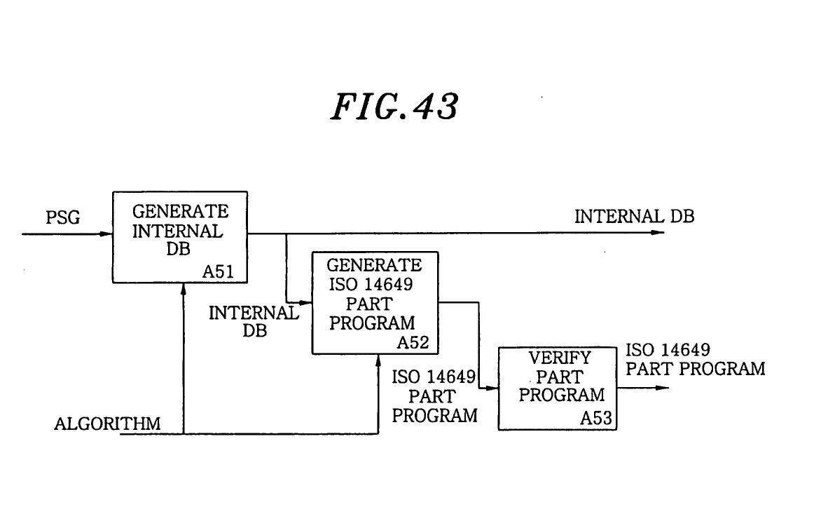

FIG. 43 shows a block diagram showing a process of generating an ISO 14649 part program based on the non-linear PSG, which is a detailed diagram of the block A5 shown in FIG. 38. In the block A5, first, an internal DB is generated based on the PSGs (block A51). The generated internal DB is then used to generate an ISO 14649 part program (block A52). Thereafter, the generated part program is verified (block A53).

Each of the steps of the operational scenario for a turning SFP system, which are described with reference to FIGS. 37 to 43, may be implemented in software executable in a general-purpose computer or a dedicated hardware for the turning SFP system. Alternatively, each of the steps of the scenario may be implemented in hardware.

A process of generating process plans and decomposing delta volumes is preferably performed with an aid of a manufacturing engineer rather than fully automated. Interactions with a manufacturing engineer may be needed in: (i) determining the number of setups to be used in turning, (ii) determining a location of a split of a profile, (iii) editing the decomposed delta volumes, (iv) selecting turning tools, (v) modifying an ordered list of operations, and (vi) determining and/or modifying parameters of a cutting tool.

While the invention has been shown and described with respect to the preferred embodiments, it will be understood by those skilled in the art that various changes and modifications may be made without departing from the spirit and scope of the invention as defined in the following claims.

1. A method for performing delta volume decomposition and process planning in a turning STEP-NC system, comprising the steps of:
(a) based on a CAD data file including geometry information on a raw stock and a finished part, recognizing a profile of the finished part;
(b) setting a machine configuration of a turning machine based on the recognized profile;
(c) splitting the profile based on the machine configuration;
(d) decomposing a delta volume corresponding to each of the split profiles;
(e) generating a dependency graph based on the decomposed delta volumes, wherein the dependency graph represents operational precedence relations between the decomposed delta volumes;
(f) generating a PSG (process sequence graph) representing a process plan based on the dependency graph;
(g) editing the decomposed delta volumes and/or the PSG; and
(h) generating a part program based on the PSG.

2. The method of claim 1, wherein the step (d) includes the steps of:
(d1) recognizing an inherent delta volume based on information on each of the split profiles;
(d2) updating an input profile by calculating a union of the inherent delta volume and the profile of the finished part;
(d3) based on the input profile, determining a reference line such that a minimum number of monotone chains are obtained based on the reference line;
(d4) determining a maximum monotone chain by connecting the monotone chains; and
(d5) selecting a first turning tool and recognizing a primary delta volume and/or an uncut delta volume based on information on the first turning tool and the maximum monotone chain.

3. The method of claim 2, wherein the step (d2) includes the steps of:
if there are more than one non-monotone segment among the monotone chains, determining a reference line such that the non-monotone segments are monotone to the reference line;
obtaining a maximum monotone chain by connecting the non-monotone segments; and
selecting a second turning tool and recognizing a primary delta volume and/or an uncut delta volume based on information on the second turning tool and the maximum monotone chain.

4. The method of claim 1, wherein the step (e) includes the steps of:
categorizing each of the decomposed delta volumes as one of a primary delta volume, a secondary delta volume and an inherent delta volume, wherein the inherent delta volume is cut after the primary delta volume and/or the secondary delta volume is cut; and
generating the dependency graph based on operational precedence relations between the primary delta volumes, the secondary delta volumes and the inherent delta volumes.

5. The method of claim 4, wherein the dependency graph. includes an auxiliary dependency indicating that the inherent delta volume is cut after the secondary delta volume.

6. The method of claim 1, wherein the step (f) includes the steps of:
assigning an operation for a delta volume to each of nodes included in the dependency graph based on the machine configuration; and
setting an operational relation between the operations.

7. The method of claim 6, wherein the operational relation is one of AND, OR and PARALLEL relations, wherein the AND relation represents a non-sequential relation between operations for delta volumes belonging to a node included in the dependency graph, the OR relation represents an auxiliary dependency represented by the dependency graph, and the PARALLEL relation represents a concurrent operation to be performed on a delta volume by using more than two turning tools.

8. The method of claim 1, wherein the turning machine includes a plurality of MUs (machining units) and the method further comprises a step (i) of assigning each of operations represented in the PSG to a corresponding MU.

9. The method of claim 8, wherein the step (i) includes the steps of:
(i1) setting T to zero, wherein T is a current point of time;
(i2) selecting a certain initial setup of the turning machine;
(i3) selecting currently available MUs in the turning machine and adding the selected MUs to AMU(T), wherein AMU(T) is a set of MUs available at a point of time T;
(i4) searching for operations in the PSGs, which are currently executable, and adding the operations to NOP(T), wherein NOP(T) is a set of operations executable at a point of time T;
(i5) based on OSR, selecting an operation OP among the operations belonging to NOP(T), wherein the OSR is a rule for selecting an operation;
(i6) based on MSR, selecting an MU M among the MUs belonging to AMU(T) and adding the selected MU M to RMU(T), wherein the MSR is a rule for selecting an MU and RMU(T) is a set of MUs operating at a point of time T;
(i7) deleting M from AMU(T) and deleting OP from NOP(T);
(i8) if AMU(T) is not empty, repeating the steps (i3) to (i7);
(i9) if AMU(T) is empty, adding min{tⱼ:jεRMU(T)} to T, wherein tⱼ is time consumed in processing an operation j; and
(i10) if all operations are completely processed, terminating the step (i), and if otherwise, repeating to the steps (i4) to (i10).

10. The method of claim 1, further comprising a step (j) of generating a PSG for performing a secondary finish contouring on the finished part based on a tolerance and a surface roughness.

11. The method of claim 10, wherein the step (j) includes steps of:
(j1) determining a significant surface of the finished part;
(j2) selecting a turning tool for each of the surfaces belonging to the sets S_{T} and S_{F}, wherein S_{T} is a set of surfaces related to the tolerance and S_{F} is a set of surfaces related to the surface roughness;
(j3) assigning to a certain group Sᵢ surfaces to be cut by using same turning tools, wherein Sᵢ is a group including surfaces to be cut by using i turning tools;
(j4) determining an ordered list Lᵢ of operations to be performed on each of the surfaces belonging to set Sᵢ; and
(j5) setting AND relations between the operations belonging to the set Lᵢ.

12. A method for decomposing a delta volume for use in a turning STEP-NC system, comprising the steps of:
(a) splitting a profile of a finished part into N profiles based on a setup and/or a machine configuration, wherein N is a positive integer;
(b) recognizing an inherent delta volume based on information on each of the split profiles;
(c) updating an input profile by calculating a union of the inherent delta volume and the profile of the finished part;
(d) based on the input profile, determining a reference line such that a minimum number of monotone chains are obtained based on the reference line;
(e) determining a maximum monotone chain by connecting the monotone chains; and
(f) selecting a first turning tool and recognizing a primary delta volume and/or an uncut delta volume based on information on the first turning tool and the maximum monotone chain.

13. The method of claim 12, wherein the step (d) includes the steps of:
if there are more than one non-monotone segment among the monotone chains, determining a reference line such that the non-monotone segments are monotone to the reference line;
obtaining a maximum monotone chain by connecting the non-monotone segments; and
selecting a second turning tool and recognizing a primary delta volume and/or an uncut delta volume based on information on the second turning tool and the maximum monotone chain.
